(19) United States
(12) Patent Application Publication
(10) Pub. No.: US 2015/0155630 A1
(43) Pub. Date: Jun. 4, 2015

(54) VERTICALLY POLARIZED ANTENNA

(71) Applicant: Nihon Dengyo Kosaku Co., Ltd., Tokyo (JP)

(72) Inventors: Huiling Jiang, Tokyo (JP); Keizo Cho, Tokyo (JP); Zhanghuan Li, Tokyo (JP)

(73) Assignee: Nihon Dengyo Kosaku Co., Ltd., Tokyo (JP)

(21) Appl. No.: 14/412,085

(22) PCT Filed: Jul. 3, 2013
(86) PCT No.: PCT/JP13/68220

§ 371 Date: Dec. 30, 2014

(30) Foreign Application Priority Data
Jul. 4, 2012 (JP) 2012-150826

(51) Int. Cl. H01Q 9/04

(52) U.S. Cl. CPC H01Q 9/045; H01Q 9/0464

(57) ABSTRACT

A vertically polarized antenna having a wide relative bandwidth while having a thin structure against vertically polarized waves. The vertically polarized antenna includes: a ground plate, a conductor plate, two or more feeding conductors, and short-circuit conductors grouped with the feeding conductors, respectively. The conductor plate is arranged parallel to the ground plate such that the whole of the conductor plate is overlapped with the ground plate when seen from a direction of a normal line of the ground plate; each of the feeding conductors connects the ground plate and the conductor plate at a position different from a center of the conductor plate; and each of the short-circuit conductors connects the ground plate and the conductor plate near the feeding conductor grouped with the short-circuit conductor.

### TECHNICAL FIELD

The present invention relates to a vertically polarized antenna, and more particularly to a vertically polarized antenna having a wide relative bandwidth while having a thin structure against vertically polarized waves.

### BACKGROUND ART

A vertical dipole antenna can be given as an example of an existing vertically polarized antenna. The vertical dipole antenna requires an antenna length corresponding to ½ of the wavelength λ of transmitted and received waves (λ/2) because of its characteristics. In addition, the vertical dipole antenna is installed vertically relative to the ground to transmit and receive vertically polarized waves. Therefore, as a vertical dipole antenna installation environment, a space having a length of λ/2 in a height direction (that is, a vertical direction relative to the ground which is a horizontal plane) is required. Thus, the vertical dipole antenna installation environment is restricted by the height direction depending on the wavelength λ, of transmitted and received waves. Accordingly, an antenna downsized more or with a structure which is thin in a height direction has been conventionally required in consideration of an antenna installation environment.

As an antenna having antenna characteristics resembling those of the vertical dipole antenna and having a structure which is thin in a height direction, a monopole antenna in which, for example, a disk-shaped ground plate 30 is attached to one element with a length of λ/4 (hereinafter also referred to as “a ground-plate-attached monopole antenna”) is known (see FIG. 1). In the ground-plate-attached monopole antenna, the element is connected at the center (a feeding point 5) of the ground plate 30.

There is also known a ground-plate-attached monopole antenna having one element bent in an L-letter shape in order to realize a ground-plate-attached monopole antenna having a thinner structure against vertically polarized waves (see FIG. 2). This element is configured with a conductor part A (with a length L₁) vertical to the ground plate and a conductor part B (with a length L₂) horizontal to the ground plate (L₁+L₂≈λ/4). Since the length of the conductor part A contributes to the thickness of the antenna (the size of the antenna against vertically polarized waves), L₁ can be designed small in order to realize a thin antenna. However, when L₁ is small, impedance matching becomes difficult, and relative bandwidth becomes narrow, generally.

Therefore, there has been developed a ground-plate-attached monopole antenna in which the L-letter shaped element structure is replaced with a structure in which one end of the one stick-shaped conductor part A (hereinafter referred to as a feeding conductor; the length of the feeding conductor is assumed to be L₁) is connected to the center of, for example, a disk-shaped conductor plate 20 (hereinafter also referred to as “a capacitance-loaded-type monopole antenna”) (see FIG. 3). The other end of the feeding conductor A is connected to the center (the feeding point 5) of the ground plate 30 as is conventionally done. With this structure, impedance matching becomes relatively easy even when the length L₁ of the feeding conductor A is small. However, the problem that the relative bandwidth is narrow still remains.

Furthermore, there has been developed a monopole antenna in which stick-shaped short-circuit conductors 15 are provided near one feeding conductor 10 (hereinafter also referred to as “a short-circuit-conductor-attached capacitance-loaded-type monopole antenna”) in view of improving impedance matching of the capacitance-loaded-type monopole antenna (see FIG. 4). One end of the feeding conductor 10 is connected to the center of the conductor plate 20, and the other end of the feeding conductor 10 is connected to the center (the feeding point 5) of the ground plate 30 as is done conventionally. One end of the short-circuit conductor 15 is connected to the conductor plate 20, and the other end of the short-circuit conductor is connected to the ground plate 30. Easiness in impedance matching changes according to the positions or number of the short-circuit conductors 15. However, it is known that, when design is performed appropriately, a short-circuit-conductor-attached capacitance-loaded-type monopole antenna having a thickness equal to or less than λ/10 can be realized. It is known that, in order to realize omni-directionality in a horizontal plane in an antenna of this type, it is only needed to connect one end of the feeding conductor 10 to the center of the conductor plate 20 and provide three or more short-circuit conductors 15 at positions radiating from the feeding point 5 as a center at equal distances and at equal intervals. Even with this structure, the problem that the relative bandwidth is narrow still remains when the length L₁ of the feeding conductor 10 is small.

For example, in the configuration shown in FIG. 4 (three short-circuit conductors 15 are arranged to realize omni-directionality in a horizontal plane), when L₁=6 mm=0.04λ_{2GHz}, distance D between the feeding conductor 10 and each short-circuit conductor 15=24 mm, the diameter of the ground plate 30=135 mm, and the diameter of the conductor plate 20=68 mm are set so that antenna resonance frequency becomes 2 GHz, the relative bandwidth under a condition that return loss S₁₁ is −10 dB or below (|S₁₁|≦−10 dB, that is, VSWR<2.0; VSWR is Voltage Standing Wave Ratio) is 11.2% (see FIG. 5).

In a conventional antenna in which two short-circuit conductors 15 are arranged at symmetrical positions with the feeding point 5 as a center (see FIG. 6), when L₁=6 mm=0.04λ_{2GHz}, the distance D between the feeding conductor 10 and each short-circuit conductor 15=18 mm, the diameter of the ground plate 30=135 mm, and the diameter of the conductor plate 20=52 mm=0.37λ_{2GHz} are set so that antenna resonance frequency becomes 2 GHz, the relative bandwidth under the condition that return loss S₁₁ is −10 dB or below (|S₁₁|≦−10 dB, that is, VSWR<2.0; VSWR is Voltage Standing Wave Ratio) is 8.3% in the case of D=18 mm (see FIG. 7. A symbol sp in FIG. 7 indicates D). FIG. 26 shows a relationship between the distance D and the relative bandwidth. As for the radiation pattern in a horizontal plane in this case, the level decreases a little in directions in which the two short-circuit conductors 15 are arranged (see FIG. 8). In FIG. 8, a symbol Phi indicates an azimuth angle relative to XYZ orthogonal coordinate axes shown in FIG. 6.

### PRIOR ART LITERATURE

### Non-Patent Literature

Non-patent literature 1: Huiling Jiang and Hiroyuki Arai, “FDTD Analysis of Low Profile Top Loaded Monopole Antenna”, IEICE TRANS. COMMUN., VOL. E85-B, NO. 11 Nov. 2002.

### SUMMARY OF THE INVENTION

### Problems to be Solved by the Invention

In view of such a situation, an object of the present invention is to provide a vertically polarized antenna having a wide relative bandwidth while having a thin structure against vertical polarization waves.

### Means to Solve the Problems

A vertically polarized antenna of the present invention is provided with a ground plate, a conductor plate, two or more feeding conductors, and short-circuit conductors grouped with the feeding conductors, respectively. The conductor plate is arranged parallel to the ground plate such that the whole of the conductor plate is overlapped with the ground plate when seen from a direction of a normal line of the ground plate; each of the feeding conductors connects the ground plate and the conductor plate at a position different from a center of the conductor plate; and each of the short-circuit conductors connects the ground plate and the conductor plate near the feeding conductor grouped with the short-circuit conductor.

### Effects of the Invention

According to the present invention, there can be realized a vertically polarized antenna having a wide relative bandwidth while having a thin structure against vertically polarized waves.

### BRIEF DESCRIPTION OF THE DRAWINGS

FIG. 1 is a perspective view of a ground-plate-attached monopole antenna;

FIG. 2 is a perspective view of a ground-plate-attached monopole antenna having an element bent in an L-letter shape;

FIG. 3 is a diagram showing an antenna structure of a capacitance-loaded-type monopole antenna, wherein FIG. 3A, FIG. 3B and FIG. 3C are a perspective view, a side view and a plane view, respectively;

FIG. 4 is a diagram showing an antenna structure of a short-circuit-conductor-attached capacitance-loaded-type monopole antenna (in the case where the number of short-circuit conductors is three), wherein FIG. 4A, FIG. 4B and FIG. 4C are a perspective view, a side view and a plane view, respectively;

FIG. 5 is a diagram showing return loss characteristics of the conventional antenna shown in FIG. 4;

FIG. 6 is a diagram showing an antenna structure of the short-circuit-conductor-attached capacitance-loaded-type monopole antenna (in the case where the number of short-circuit conductors is two);

FIG. 7 is a diagram showing return loss characteristics of the conventional antenna shown in FIG. 6;

FIG. 8 is a diagram showing the radiation pattern in a horizontal plane of the conventional antenna shown in FIG. 6;

FIG. 9 is a diagram showing examples of the shape of a conductor plate, wherein FIG. 9A, FIG. 9B, FIG. 9C and FIG. 9D are examples of a circular plate, a square flat plate, a ring-shaped flat plate and a holed square flat plate, respectively;

FIG. 10 is a diagram showing a structure of a vertically polarized antenna 1 of an embodiment (in the case where the number of feeding conductors is three), wherein FIG. 10A, FIG. 10B and FIG. 10C are a perspective view, a side view and a plane view, respectively;

FIG. 11 is a diagram showing a structure of the vertically polarized antenna 1 of the embodiment (in the case where the number of feeding conductors is four), wherein FIG. 11A, FIG. 11B and FIG. 11C are a perspective view, a side view and a plane view, respectively;

FIG. 12 is a diagram showing the current distribution and current intensity of the vertically polarized antenna 1 shown in FIG. 16, wherein FIG. 12A and FIG. 12B are a side view and a plane view of the conductor plate 20, respectively;

FIG. 13 is a diagram showing the current distribution and current intensity of the conventional antenna shown in FIG. 6, wherein FIG. 13A and FIG. 13B are a side view and a plane view of the conductor plate 20, respectively;

FIG. 14 is a diagram showing a structure of the vertically polarized antenna 1 of the embodiment (each short-circuit conductor is arranged at a position shifted counterclockwise by an angle φ from a line connecting the center of the conductor plate and a connection portion between the feeding conductor and the conductor plate, with a distance relative to the center of the conductor plate being maintained);

FIG. 15 is a diagram showing return loss characteristics of the antenna shown in FIG. 14;

FIG. 16 is a diagram showing a structure of the vertically polarized antenna 1 of the embodiment (in the case where each of the number of feeding conductors and the number of short-circuit conductors is two), wherein FIG. 16A, FIG. 16B and FIG. 16C are a perspective view, a side view and a plane view, respectively;

FIG. 17 is a diagram showing return loss characteristics of the antenna shown in FIG. 16;

FIG. 18 is a diagram showing the radiation pattern in a horizontal plane of the antenna shown in FIG. 16;

FIG. 19 is a diagram showing return loss characteristics of the antenna shown in FIG. 16;

FIG. 20 is a diagram showing return loss characteristics of the antenna shown in FIG. 10;

FIG. 21 is a diagram showing return loss characteristics of the antenna shown in FIG. 11;

FIG. 22 is a diagram showing a structure of a vertically polarized antenna 2 of an embodiment (in the case where each of the number of feeding conductors and the number of short-circuit conductors is four);

FIG. 23 is a diagram showing return loss characteristics of the antenna shown in FIG. 22;

FIG. 24 is a diagram showing radiation pattern characteristics of the antenna shown in FIG. 22;

FIG. 25 is a diagram showing a structure of the vertically polarized antenna 2 of the embodiment (in the case where each of the number of feeding conductors and the number of short-circuit conductors is three);

FIG. 26 is a diagram showing a relationship between a distance D between a feeding conductor 10 and each short-circuit conductor 15, and a relative bandwidth in the conventional antenna shown in FIG. 6;

FIG. 27 is a diagram showing a relationship between a distance D between a feeding conductor 10 and a short-circuit conductor 15 to be grouped therewith, and a relative bandwidth in the antenna shown in FIG. 16;

FIG. 28 is a diagram illustrating arrangement of multiple short-circuit conductors relative to feeding conductors;

FIG. 29 is a diagram illustrating arrangement of multiple short-circuit conductors relative to feeding conductors;

FIG. 30 is a diagram illustrating arrangement of multiple short-circuit conductors relative to feeding conductors; and

FIG. 31 is a diagram showing a structure of a modification of the antenna shown in FIG. 10 (in the case where the number of feeding conductors is three).

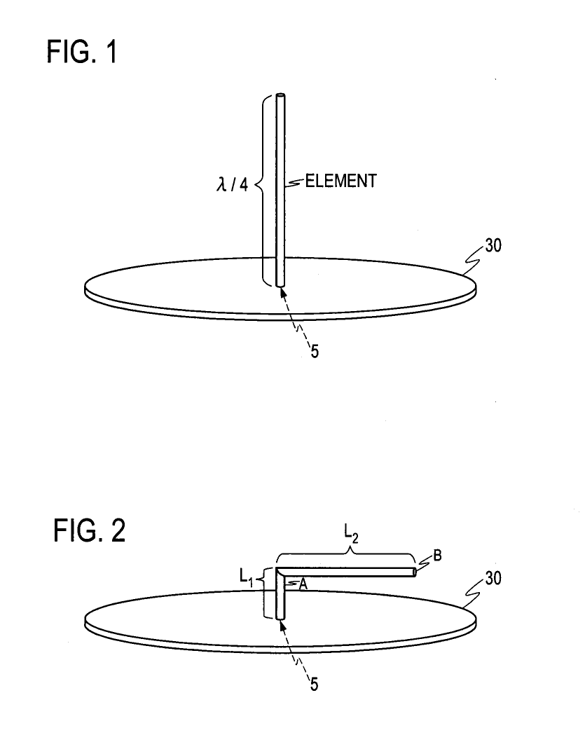

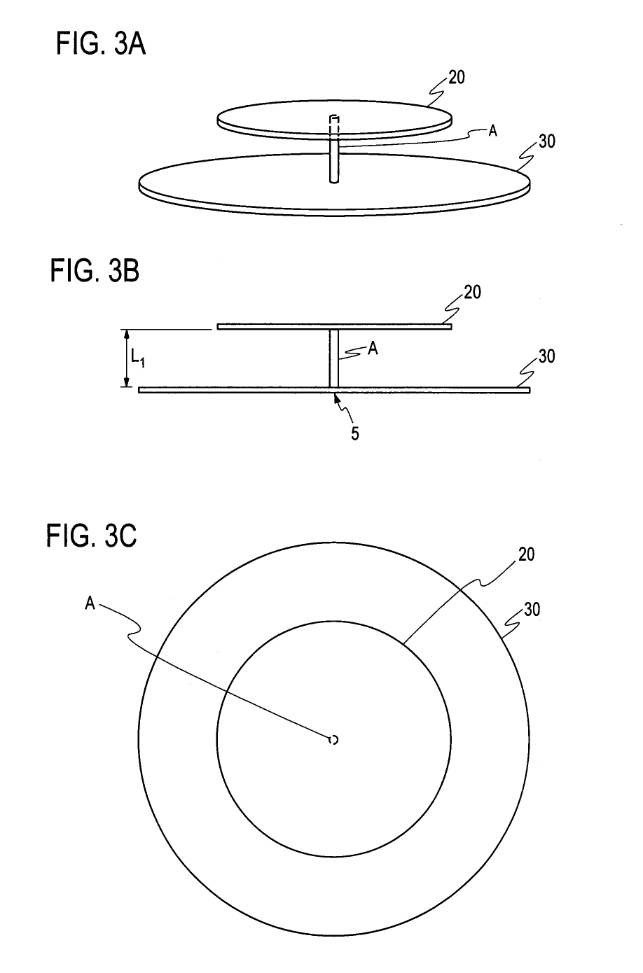

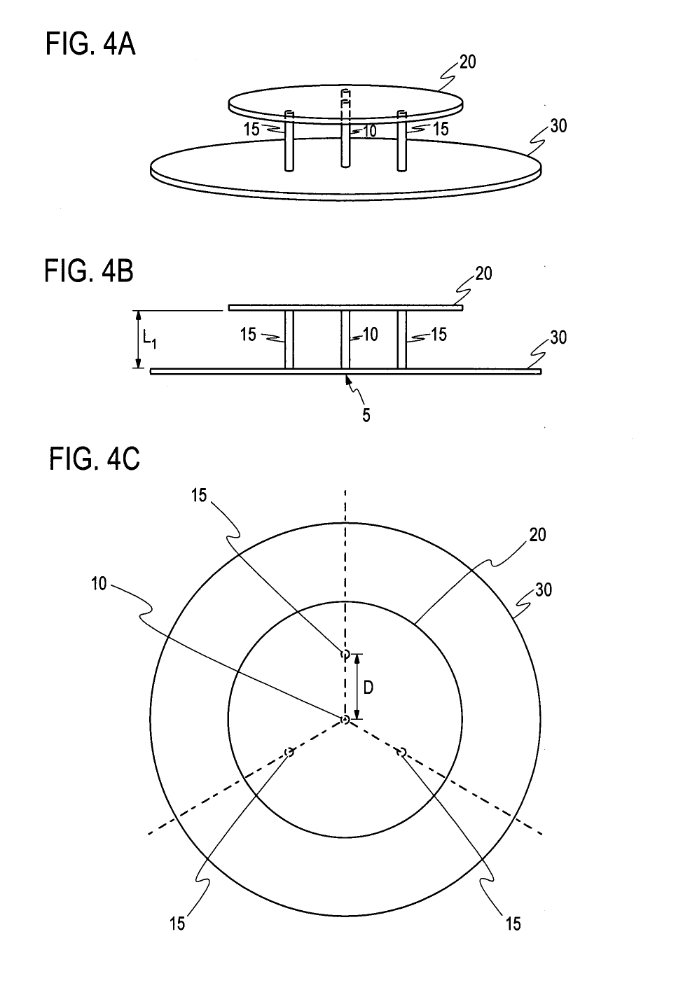

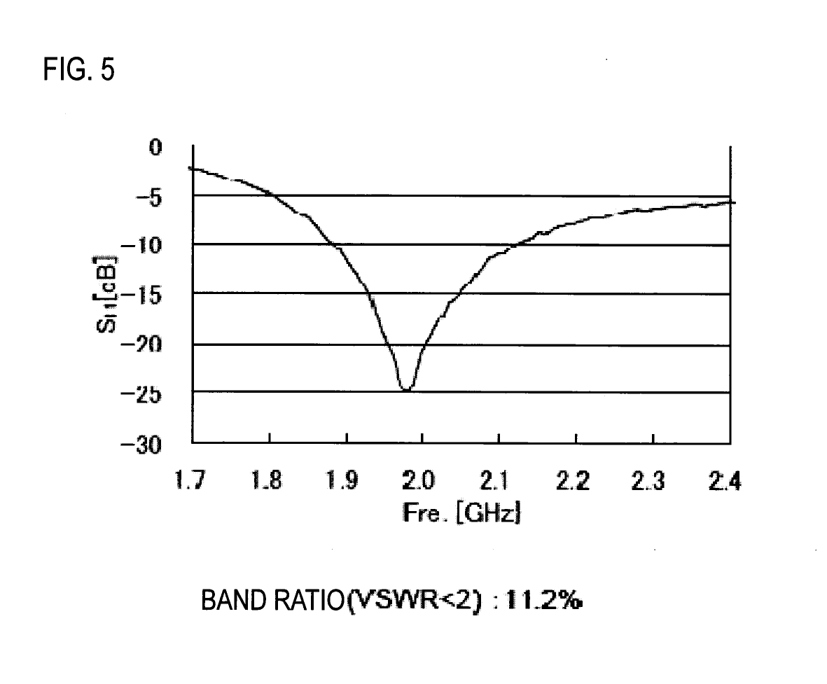

### DETAILED DESCRIPTION OF THE EMBODIMENTS

Embodiments of the present invention will be described with reference to drawings. Components common to the embodiments are assigned the same reference numerals, and repeated description will be omitted.

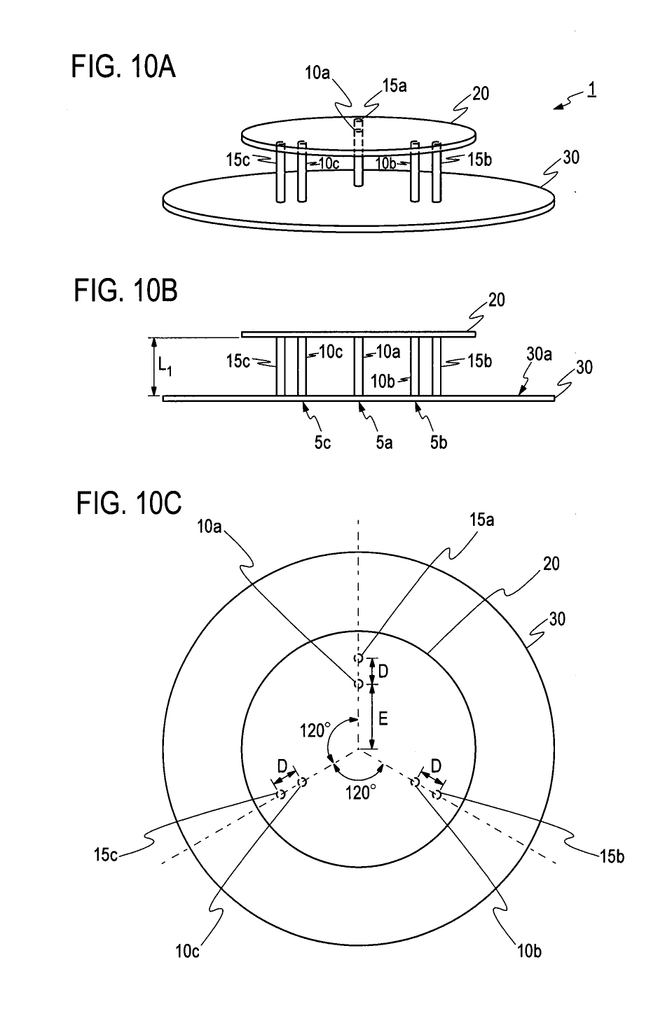

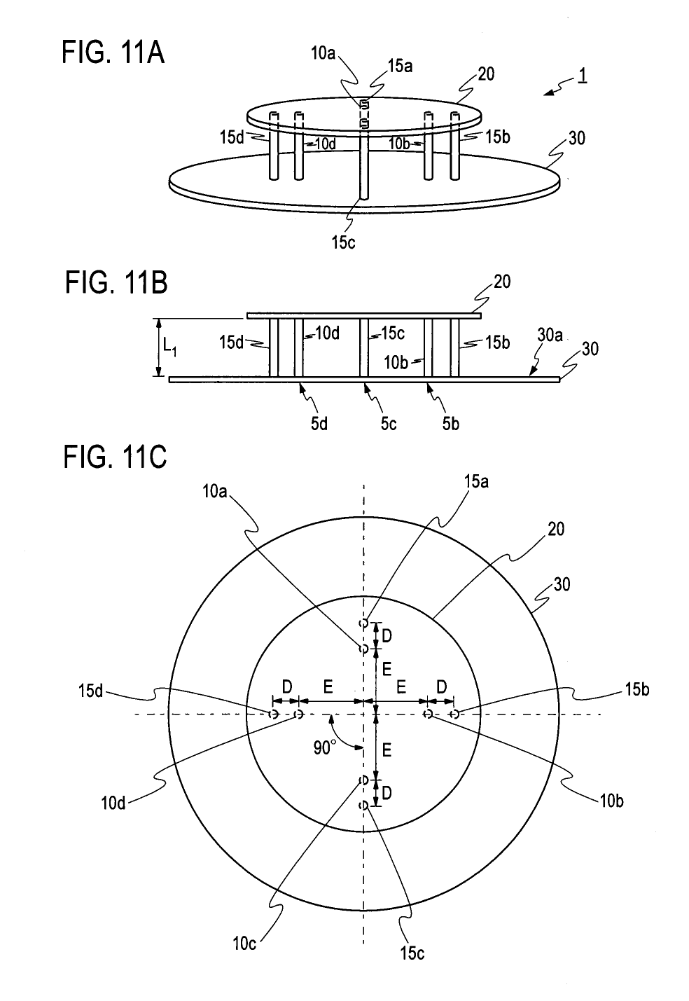

A vertically polarized antenna 1 (see FIGS. 10 and 11) of an embodiment is provided with one ground plate 30, one conductor plate 20, two or more feeding conductors 10, short-circuit conductors 15 grouped with the feeding conductors 10, respectively. The material of these members is not especially limited if the material has conductivity. The material is, for example, metal. The shape of each feeding conductor 10 is, for example, a stick shape, and the shape of each short-circuit conductor 15 is also, for example, a stick shape.

FIGS. 10 and 11 illustrate the vertically polarized antenna 1 in the case where the ground plate 30 and the conductor plate 20 are circular plates.

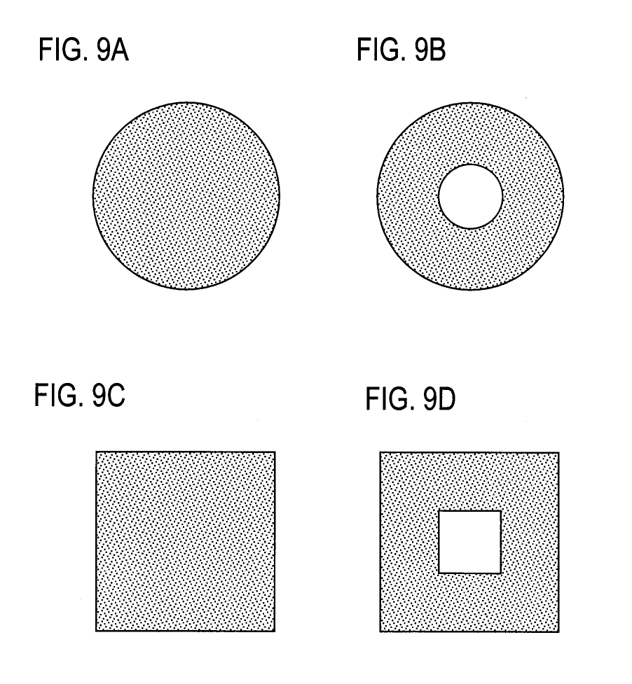

The shape of the conductor plate 20 is not especially limited, and the conductor plate 20 is, for example, a circulate plate, an oval flat plate, a polygonal flat plate (including a square flat plate), a ring-shaped flat plate (a holed circular plate), a holed polygonal flat plate (including a holed square flat plate) and the like. The shape of the hole is not limited. Generally, the shape of the hole is similar to the external shape of the conductor plate 20 in consideration of easiness in design and the like. Generally, a circular plate, a square flat plate, a regular polygonal flat plate with the number of sides equal to or larger than that of a regular pentagon, a ring-shaped flat plate or a holed regular polygonal flat plate is selected as the shape of the conductor plate 20 in consideration of easiness in design (see FIG. 9).

If the conductor plate 20 is a circular plate, the diameter of the circular plate is set according to a desired resonance frequency.

If, when the shape of the ground plate 30 is a circular plate, the diameter is equal to or more than a half wavelength or if, when the shape of the ground plate 30 is a rectangular shape, the length of shorter sides is equal to or more than a half wavelength, the shape does not influence the resonance frequency of an antenna, and, therefore, any shape can be adopted irrespective of the shape of the conductor plate 20. Thus, the shape of the ground plate 30 is not especially limited, and, for example, a circular plate, an oval flat plate, a polygonal flat plate (including a square flat plate), a ring-shaped flat plate (a holed circular plate), a holed polygonal flat plate (including a holed square flat plate) and the like can be shown as examples. Generally, however, a circular plate, a square flat plate or a regular polygonal flat plate with the number of sides equal to or larger than that of a regular pentagon is selected as the shape of the ground plate 30 in consideration of easiness in design.

The conductor plate 20 is arranged parallel to the ground plate 30 such that the whole of the conductor plate 20 is overlapped with the ground plate 30 when seen from the direction of the normal line of the ground plate 30 (that is, a direction vertical to a plane 30a of the ground plate 30). In other words, when the conductor plate 20 is orthogonally projected along the direction of the normal line of the ground plate 30, the projection of the conductor plate 20 is included within the ground plate 30.

Here, “the center of the conductor plate 20” is defined as the geometrical center of the conductor plate 20. For example, if the conductor plate 20 is a circular plate, the center of the circle is defined as “the center of the conductor plate 20”. If the conductor plate 20 is a square flat plate, a position where the diagonal lines of the square intersect with each other is defined as “the center of the conductor plate 20”. If the conductor plate 20 is a ring-shaped flat plate, the center of the outer circle is defined as “the center of the conductor plate 20”. If the conductor plate 20 is a holed square flat plate, a position where the diagonal lines of the square intersect with each other is defined as “the center of the conductor plate 20” (in the case where the conductor plate 20 is a holed square flat plate, the hole is formed, for example, such that the shape of the hole is also a square, the center of the hole corresponds to the center of the conductor plate 20, and the diagonal lines of the conductor plate 20 correspond to the diagonal lines of the hole).

Furthermore, “the center of the ground plate 30” is defined as the geometrical center of the ground plate 30 (hereinafter referred to as “the center of the ground plate 30” in a narrow sense). For example, if the ground plate 30 is a circular plate, the center of the circle is defined as “the center of the ground plate 30”. If the ground plate 30 is a square flat plate, a position where the diagonal lines of the square intersect with each other is defined as “the center of the ground plate 30”. If the ground plate 30 is a ring-shaped flat plate, the center of the outer circle is defined as “the center of the ground plate 30”. If the ground plate 30 is a holed square flat plate, a position where the diagonal lines of the square intersect with each other is defined as “the center of the ground plate 30” (in the case where the ground plate 30 is a holed square flat plate, the hole is formed, for example, such that the shape of the hole is also a square, the center of the hole corresponds to the center of the ground plate 30, and the diagonal lines of the ground plate 30 correspond to the diagonal lines of the hole).

Based on the above definitions, it can be explained that, in the vertically polarized antenna 1 shown in FIGS. 10 and 11, “the conductor plate 20 is arranged parallel to the ground plate 30 such that the center of the conductor plate 20 and the center of the ground plate 30 are positioned on one virtual straight line which is parallel to the direction of the normal line of the ground plate 30”.

However, if a relative positional relationship between the conductor plate 20 and the ground plate 30 satisfies the above condition that “when the conductor plate 20 is orthogonally projected along the direction of the normal line of the ground plate 30, the projection of the conductor plate 20 is included within the ground plate 30”, it is sufficient. Therefore, at least the above definition in a narrow sense about “the center of the ground plate 30” is not essential. Accordingly, in the description below, “the center of the ground plate 30” is defined as “the orthogonal projection of the center of the conductor plate 20 along the direction of the normal line of the ground plate 30” (hereinafter referred to as “the center of the ground plate 30” in a broad sense).

A distance L₁ between the ground plate 30 and the conductor plate 20 is appropriately set according to a desired relative bandwidth and the like. According to the embodiment, the distance L₁ between the ground plate 30 and the conductor plate 20 can be, for example, 0.04λ (a length corresponding to 1/25 of the wavelength λ of transmitted and received waves).

The two or more feeding conductors 10 connect the ground plate 30 and the conductor plate 20 at positions different from the center of the conductor plate 20 (which may be also referred to as “the center of the ground plate 30” in a broad sense), and each of the two or more short-circuit conductors 15 connects the ground plate 30 and the above conductor plate 20 near a feeding conductor 10 grouped with the short-circuit conductor 15 (excluding the center of the conductor plate 20). In the example shown in FIGS. 10 and 11, the number of the feeding conductors 10 and the number of the short-circuit conductors 15 are the same (that is, the number of short-circuit conductors 15 constituting a group with any one feeding conductor 10 is one).

For example, in the vertically polarized antenna 1 shown in FIG. 10, each of the number of the feeding conductors 10 and the number of the short-circuit conductors 15 is three. When alphabetical letters are added to reference numerals to identify each conductor, the vertically polarized antenna 1 is provided with three feeding conductors 10a, 10b and 10c and three short-circuit conductors 15a, 15b and 15c, the feeding conductor 10a and the short-circuit conductor 15a constituting one group, the feeding conductor 10b and the short-circuit conductor 15b constituting one group, and the feeding conductor 10c and the short-circuit conductor 15c constituting one group.

In the vertically polarized antenna 1 shown in FIG. 11, each of the number of the feeding conductors 10 and the number of the short-circuit conductors 15 is four. When alphabetical letters are added to reference numerals to identify each conductor, the vertically polarized antenna 1 is provided with four feeding conductors 10a, 10b, 10c and 10d and four short-circuit conductors 15a, 15b, 15c and 15d, the feeding conductor 10a and the short-circuit conductor 15a constituting one group, the feeding conductor 10b and the short-circuit conductor 15b constituting one group, the feeding conductor 10c and the short-circuit conductor 15c constituting one group, and the feeding conductor 10d and the short-circuit conductor 15d constituting one group.

However, the configuration is not limited to the configuration in which the number of short-circuit conductors 15 constituting a group with any one feeding conductor 10 is one. When the number of the feeding conductors 10 is indicated by N (N≧2), and the number of the short-circuit conductors 15 is indicated by M, N≧M is preferably satisfied. More preferably, M=α×N is satisfied, where a is an integer equal to or larger than 1. When M=α×N is satisfied, any one feeding conductor 10 constitutes a group with one or more short-circuit conductors 15, and, preferably, any one feeding conductor 10 constitutes a group with α short-circuit conductors 15.

More preferably, in each group, multiple short-circuit conductors are arranged at positions having symmetry relative to the feeding conductor 10. As examples of the “positions having symmetry relative to the feeding conductor 10”, the following are given: (1) positions at equal distances and at equal intervals with the feeding conductor 10 as a center; and (2) when at least one virtual axis passing through the feeding conductor 10 (assumed to be parallel to the conductor plate 20) is arbitrarily defined, positions at equal distances and symmetrical relative to the virtual axis, with the feeding conductor 10 as a center.

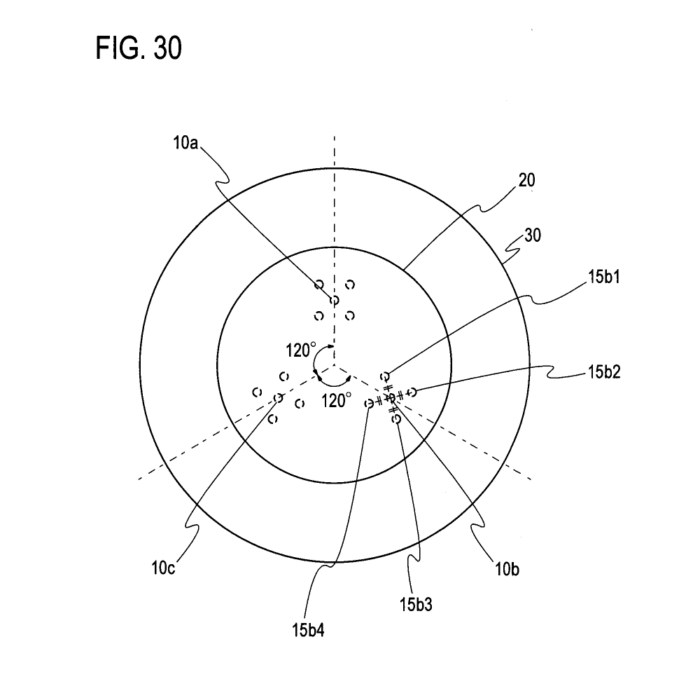

A configuration in FIG. 30 can be given as an example of the configuration of (1). FIG. 30 illustrates a case where the number of the feeding conductors 10 is three, and each feeding conductor 10 constitutes a group with four short-circuit conductors 15. Specifically, the feeding conductor 10b constitutes a group with four short-circuit conductors 15b1, 15b2, 15b3 and 15b4, and the short-circuit conductors 15b1, 15b2, 15b3 and 15b4 are positioned at equal distances and at equal intervals with the feeding conductor 10b as a center. The same goes for the other groups. However, when the three feeding conductors 10a, 10b and 10c are arranged at equal distances and at equal intervals relative to the center of the conductor plate 20, it is desirable to consider symmetry of arrangement of the twelve short-circuit conductors in the whole antenna. That is, in this example, the four short-circuit conductors for the feeding conductor 10a are arranged at positions determined by rotating the positions of the four short-circuit conductors 15b1, 15b2, 15b3 and 15b4 for the feeding conductor 10b counterclockwise by 120° relative to the center of the conductor plate 20 as they are, respectively; and the four short-circuit conductors for the feeding conductor 10c are arranged at positions determined by rotating the positions of the four short-circuit conductors 15b1, 15b2, 15b3 and 15b4 counterclockwise by 240°, respectively. In order to avoid the figure from being complicated, reference numerals of the short-circuit conductors 15 corresponding to the feeding conductors 10a and 10c are omitted.

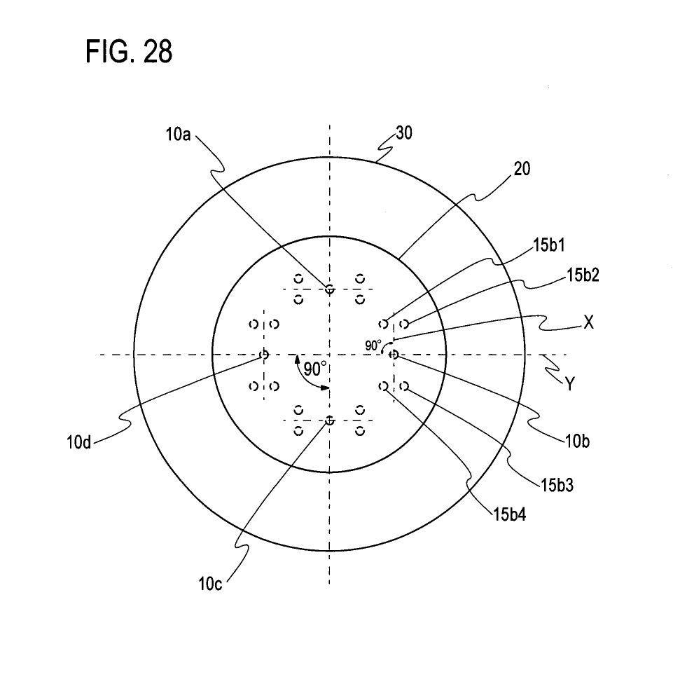

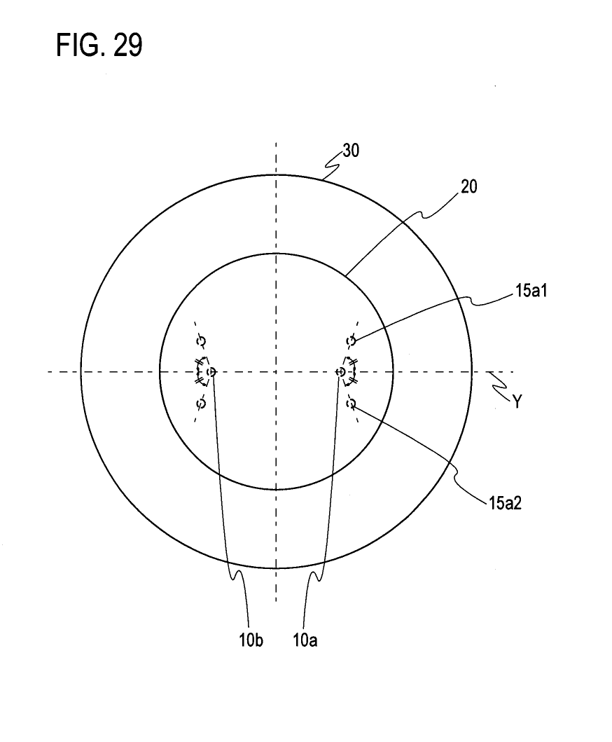

Each of configurations in FIGS. 28 and 29 can be given as an example of the configuration of (2). FIG. 28 illustrates a case where the number of the feeding conductors 10 is four, and each feeding conductor 10 constitutes a group with four short-circuit conductors 15. Specifically, the feeding conductor 10b constitutes a group with the four short-circuit conductors 15b1, 15b2, 15b3 and 15b4; and the short-circuit conductors 15b1, 15b2, 15b3 and 15b4 exist at positions at equal distances with the feeding conductor 10b as a center. As for two virtual axes X and Y intersecting with each other at right angles, the short-circuit conductor 15b1 and the short-circuit conductor 15b2 exist at symmetrical positions relative to the virtual axis X; the short-circuit conductor 15b3 and the short-circuit conductor 15b4 exist at symmetrical positions relative to the virtual axis X; the short-circuit conductor 15b1 and the short-circuit conductor 15b4 exist at symmetrical positions relative to the virtual axis Y; and the short-circuit conductor 15b2 and the short-circuit conductor 15b3 exist at symmetrical positions relative to the virtual axis Y. The same goes for the other groups. However, when the four feeding conductors 10a, 10b, 10c and 10d are arranged at equal distances and at equal intervals relative to the center of the conductor plate 20, it is desirable to consider symmetry of arrangement of the sixteen short-circuit conductors in the whole antenna. That is, in this example, the four short-circuit conductors for the feeding conductor 10a are arranged at positions determined by rotating the positions of the four short-circuit conductors 15b1, 15b2, 15b3 and 15b4 for the feeding conductor 10b counterclockwise by 90° relative to the center of the conductor plate 20 as they are, respectively; the four short-circuit conductors for the feeding conductors 10d are arranged at positions determined by rotating the positions of the four short-circuit conductors 15b1, 15b2, 15b3 and 15b4 counterclockwise by 180°, respectively; and the four short-circuit conductors for the feeding conductor 10c are arranged at positions determined by rotating the positions of the four short-circuit conductors 15b1, 15b2, 15b3 and 15b4 counterclockwise by 270°, respectively. In order to avoid the figures from being complicated, reference numerals of the short-circuit conductors 15 corresponding to the feeding conductors 10a, 10c and 10d are omitted.

FIG. 29 illustrates a case where the number of the feeding conductors 10 is two, and each feeding conductor 10 constitutes a group with two short-circuit conductors 15. Specifically, the feeding conductor 10a constitutes a group with two short-circuit conductors 15a1 and 15a2; the short-circuit conductors 15a1 and 15a2 exist at positions at equal distances with the feeding conductor 10a as a center; and the short-circuit conductors 15a1 and 15a2 exist at symmetrical positions relative to the virtual axis Y. The same goes for the other groups. However, when the two feeding conductors 10a and 10b are arranged at equal distances and at equal intervals relative to the center of the conductor plate 20, it is desirable to consider symmetry of arrangement of the four short-circuit conductors in the whole antenna. That is, in this example, the two short-circuit conductors for the feeding conductor 10b are arranged at positions determined by rotating the positions of the two short-circuit conductors 15a1 and 15a2 for the feeding conductor 10a clockwise by 180° relative to the center of the conductor plate 20 as they are, respectively. Reference numerals of the short-circuit conductors 15 corresponding to the feeding conductor 10b are omitted.

Each feeding conductor 10 is generally an inner conductor of a feeding line (not shown). In this case, an outer conductor (not shown) of the feeding line is connected to the ground plate 30. More specifically, the ground plate 30 is provided with through holes at feeding points 5 (feeding points 5a, 5b and 5c in the example in FIG. 10, and feeding points 5a, 5b, 5c and 5d in the example in FIG. 11); and the inner conductors of the feeding lines are inserted through the through holes, maintaining insulation from the ground plate 30. Furthermore, by the inner conductors of the feeding lines being physically/mechanically connected to the conductor plate 20, electrical connection between the inner conductors of the feeding lines and the conductor plate 20 is secured. The outer conductors of the feeding lines are physically/mechanically connected to the ground plate 30 to secure electrical connection between the outer conductors of the feeding lines and the ground plate 30.

Each feeding conductor 10 and each short-circuit conductor 15 are preferably arranged parallel to the direction of the normal line of the ground plate 30. In other words, each of the feeding conductors 10 and the short-circuit conductors 15 has almost the same length as the distance between the ground plate 30 and the conductor plate 20.

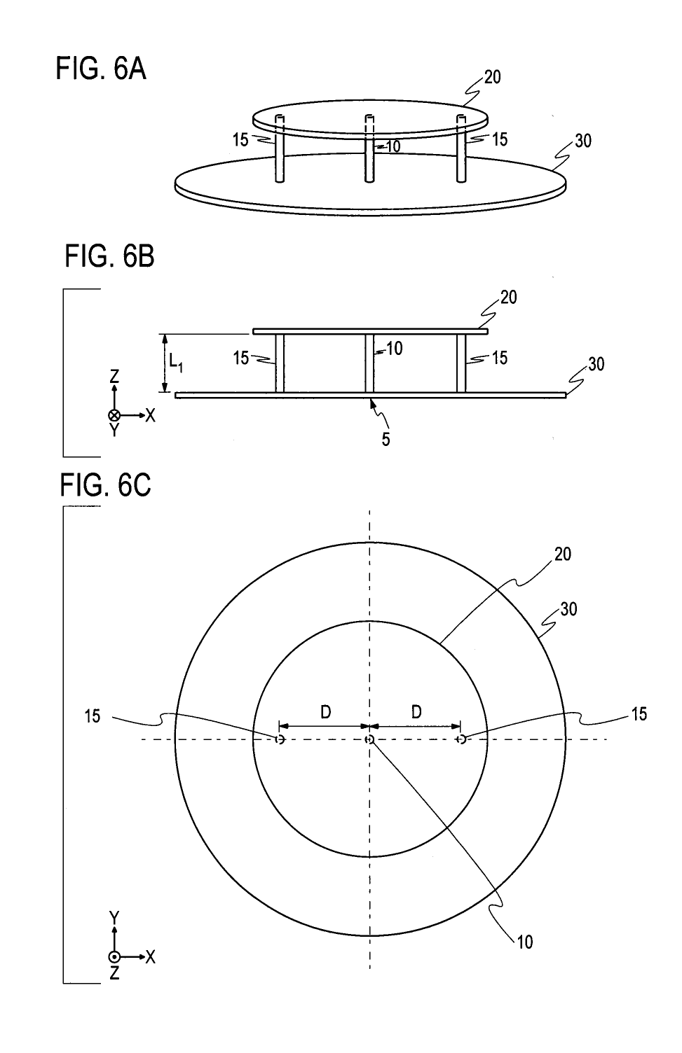

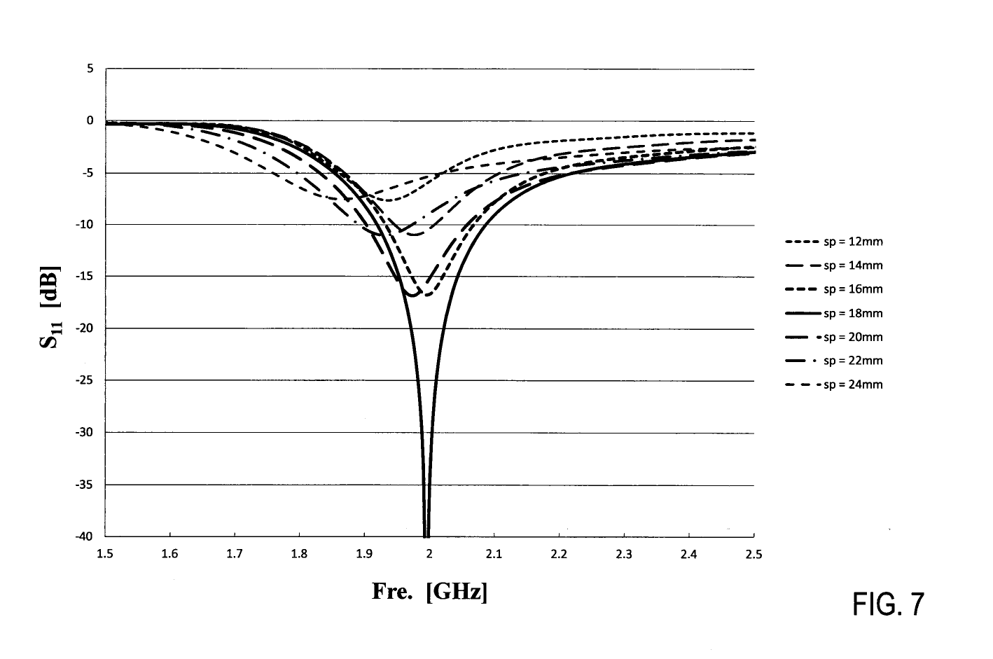

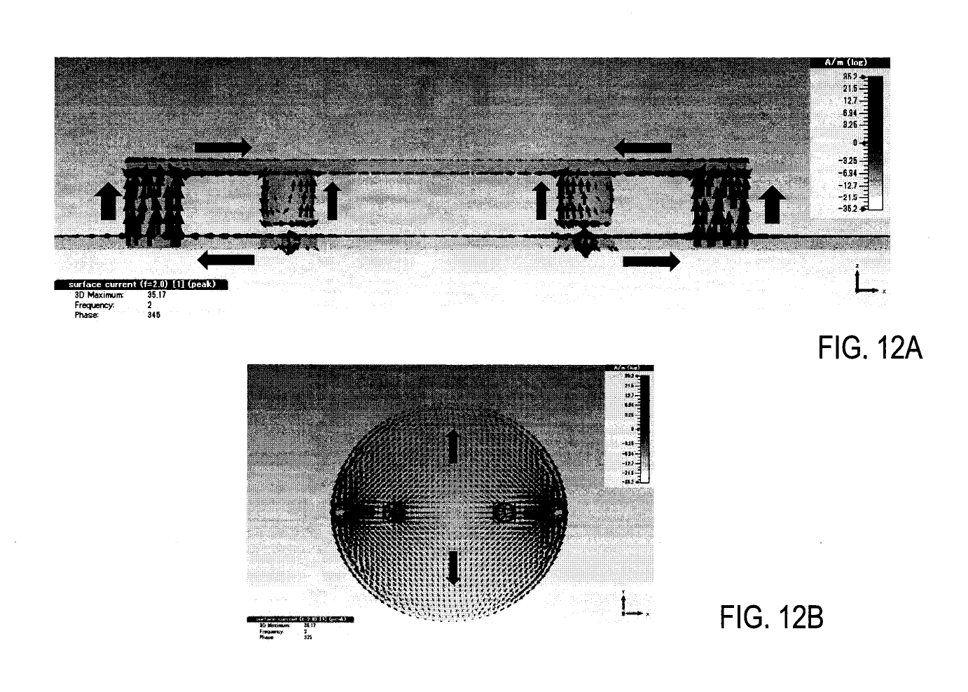

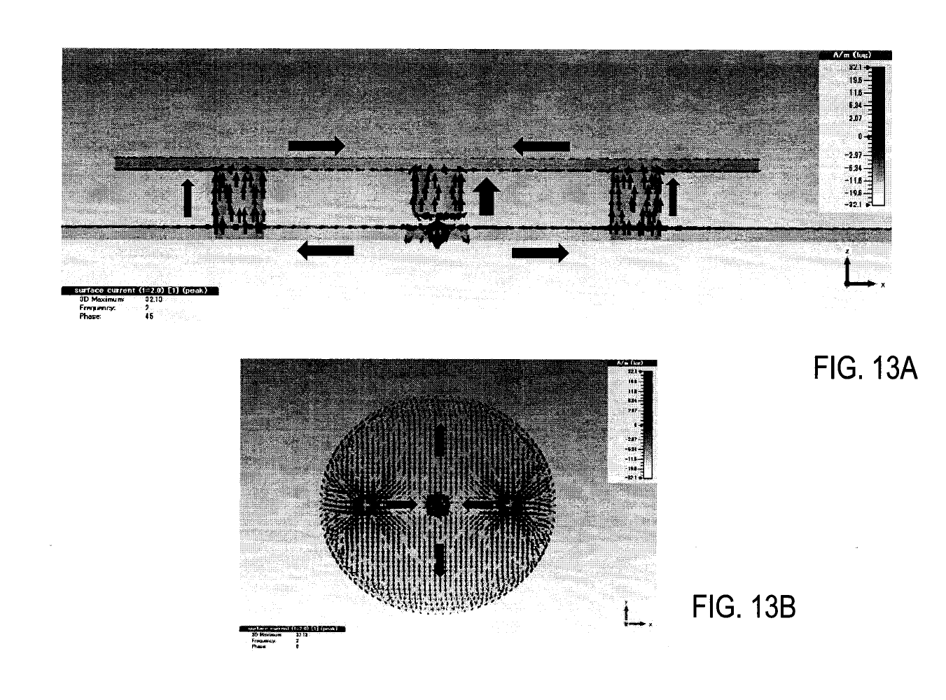

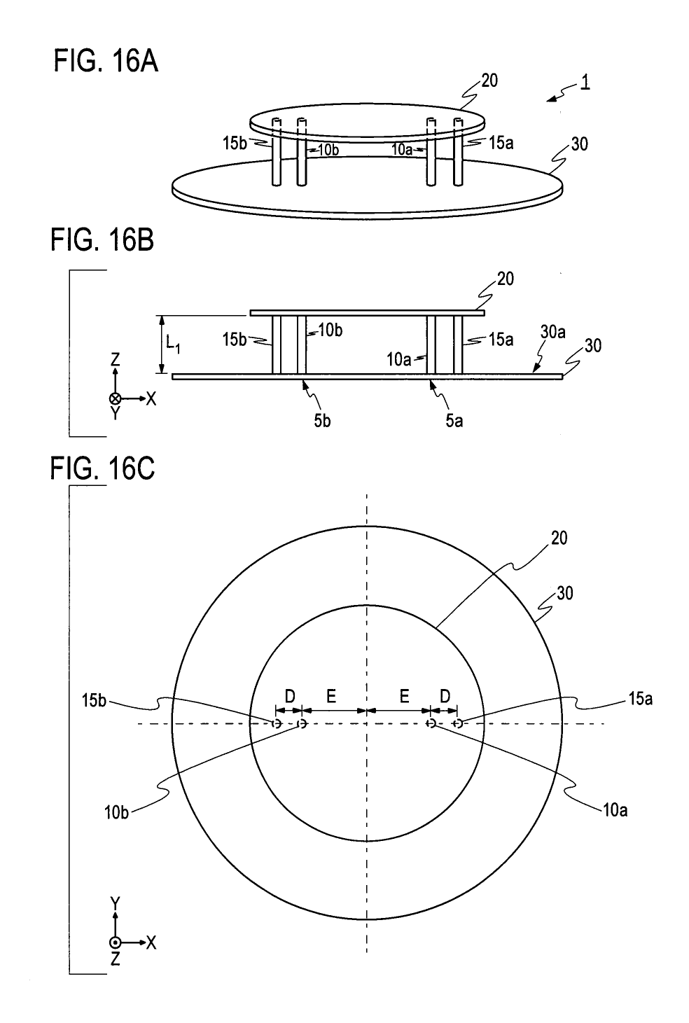

Each short-circuit conductor 15 is preferably positioned near a feeding conductor 10 grouped with the short-circuit conductor 15 on a side away from the center of the conductor plate 20 (which may be also referred to as “the center of the ground plate 30” in a broad sense). The reason is that, since the peripheral part of the conductor plate 20 corresponds to the open end of the antenna, and the capacitive can be improved by causing short-circuit at a position on a side near the open end when seen from the feeding conductor 10, impedance matching of the antenna becomes easy, and, additionally, it becomes easy to secure a band as a result. In addition to such a reason, another reason is that, as seen from current distribution and current intensity shown in FIG. 12, the electrical potential near the center of the conductor plate 20 is almost zero, and, therefore, the above effect cannot be expected even if short-circuit is caused at a position on the side near the center of the conductor plate 20 when seen from the feeding conductors 10. FIG. 12 shows the current distribution and current intensity of the vertically polarized antenna 1 shown in FIG. 16 (which includes the two feeding conductors 10a and 10b and the two short-circuit conductors 15a and 15b) to be described later. Even in the vertically polarized antenna 1 having a configuration in which three or more feeding conductors and three or more short-circuit conductors are included, the electrical potential near the center of the conductor plate 20 is almost zero. As a comparison example, current distribution and current intensity of the conventional antenna shown in FIG. 6 is shown in FIG. 13. It is seen from FIG. 13 that, in the conventional antenna, the electrical potential near the center of the conductor plate 20 is not almost zero.

According to the examples shown in FIGS. 10 and 11, for example, the short-circuit conductor 15a is positioned near the feeding conductor 10a grouped with the short-circuit conductor 15a on the side away from the center of the conductor plate 20. Specifically, a connection portion between the short-circuit conductor 15a and the conductor plate 20 is located on a line connecting the center of the conductor plate 20 and a connection portion between the feeding conductor 10a and the conductor plate 20, and located between the connection portion and the edge of the conductor plate 20. The same goes for the other groups.

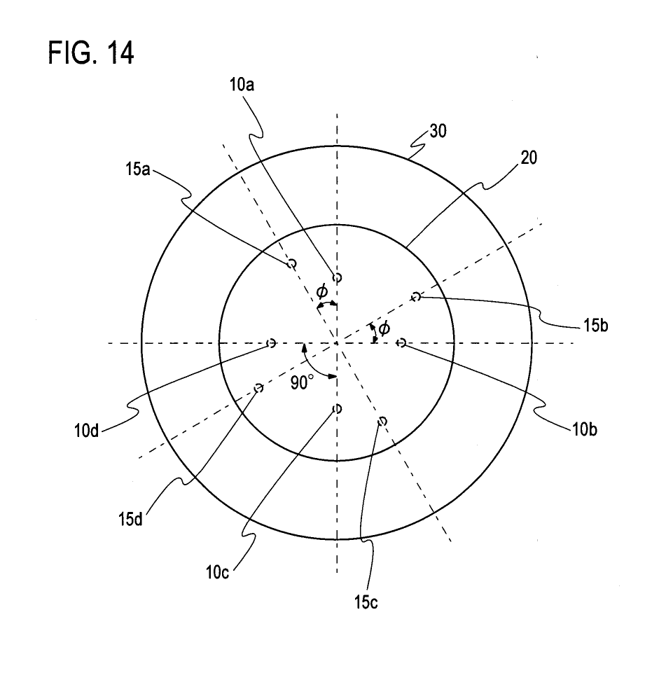

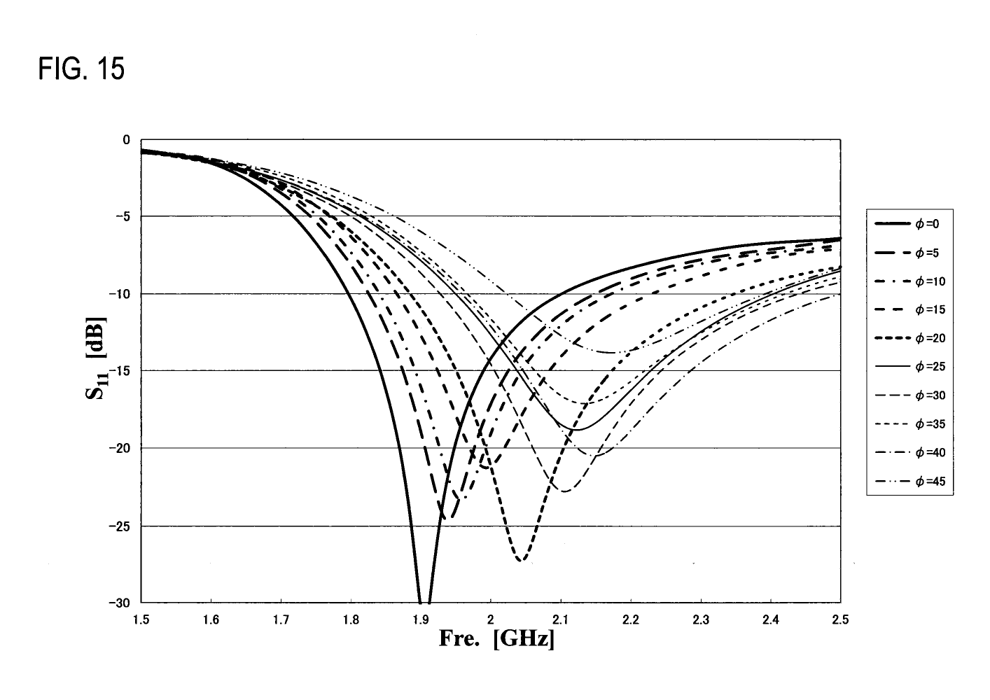

However, it is not an indispensable technical matter that connection portions between the short-circuit conductors 15 and the conductor plate 20 are positioned on lines connecting the center of the conductor plate 20 and connection portions between the feeding conductors 10 and the conductor plate 20. FIG. 15 shows return loss characteristics at the time when the positions of the short-circuit conductors 15 are shifted counterclockwise by an angle φ from the lines connecting the center of the conductor plate 20 and the connection portions between the feeding conductors 10 and the conductor plate 20 while distances relative to the center of the conductor plate 20 are maintained, as shown in FIG. 14 (in the case of φ=0°, the connection portions between the short-circuit conductors 15 and the conductor plate 20 are positioned on the lines connecting the center of the conductor plate 20 and the connection portions between the feeding conductors 10 and the conductor plate 20). The return loss characteristics shown in FIG. 15 are characteristics in the case where, in the structure of the vertically polarized antenna 1 shown in FIG. 14, the following are set: the distance L₁ between the ground plate 30 and the conductor plate 20=6 mm=0.04λ_{2GHz}, the distance D between a feeding conductor 10 and a short-circuit conductor 15 grouped with each other=6.5 mm=0.04λ_{2GHz}, distance E between the center of the conductor plate 20 and each feeding conductor 10=17.5 mm=0.12λ_{2GHz}, the diameter of the ground plate 30=137 mm=0.9λ_{2GHz}, and the diameter of the conductor plate 20=74 mm=0.49λ_{2GHz}.

As apparent from FIG. 15, the antenna bandwidth becomes wider as φ becomes larger. Though the resonance frequency of the antenna shifts to the high frequency side as φ becomes larger, enlargement of the bandwidth reduces influence on practicality of the antenna caused by the shift. In other words, by determining the size of φ, that is, relative positions of the short-circuit conductors 15 relative to the feeding conductors 10 in consideration of the relationship between bandwidth and resonance frequency, it is possible to realize a wide-band antenna with a desired resonance frequency. In the structure of the vertically polarized antenna 1 shown in FIG. 14, even if shifting positions clockwise by the angle φ, the same return loss characteristics as those in the case of shifting the positions counterclockwise by the angle φ are shown due to the symmetry of the arrangement of each feeding conductor 10 and the arrangement of each short-circuit conductor 15, though it is not shown.

The distance between each feeding conductor 10 and the center of the conductor plate 20 is appropriately set in consideration of a desired bandwidth, impedance matching and the like.

The distance between the feeding conductor 10a and the short-circuit conductor 15a, in other words, the distance between the connection portion between the feeding conductor 10a and the conductor plate 20 and the connection portion between the short-circuit conductor 15a and the conductor plate 20 is appropriately set in consideration of a desired bandwidth, impedance matching and the like. The same goes for the other groups.

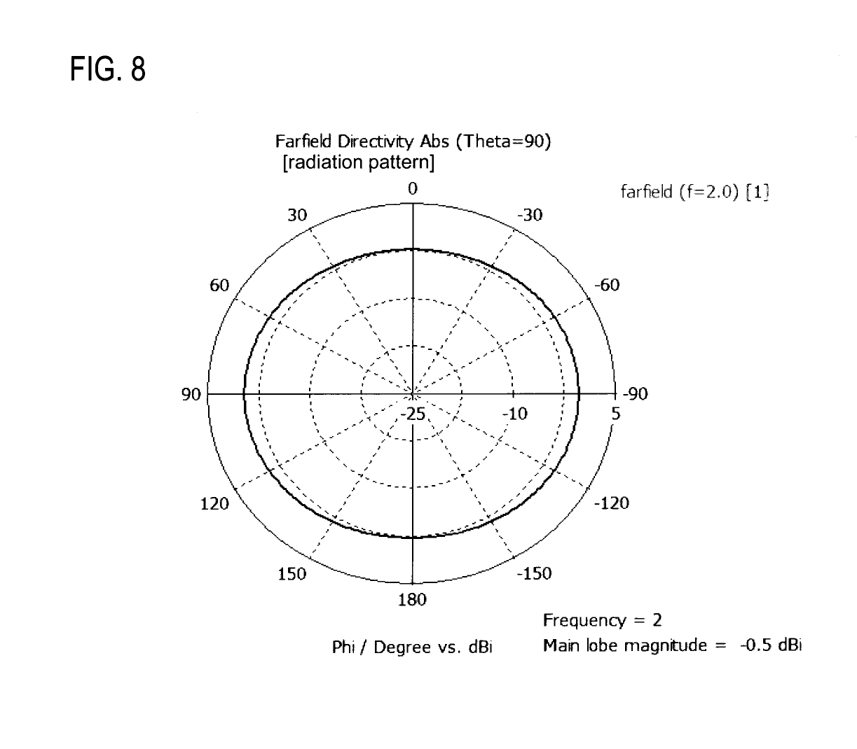

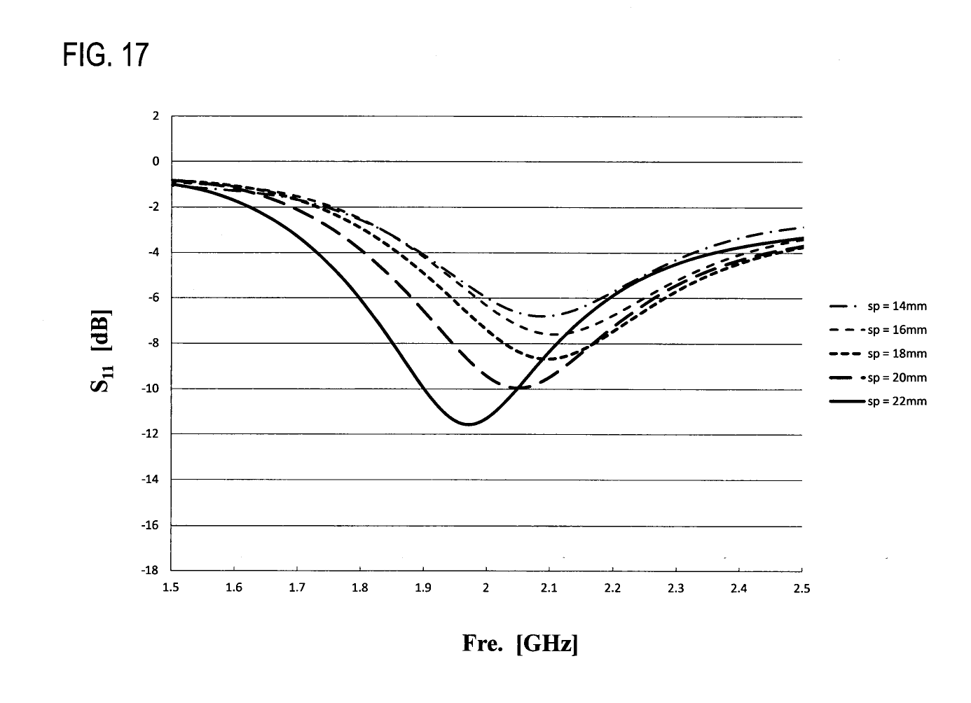

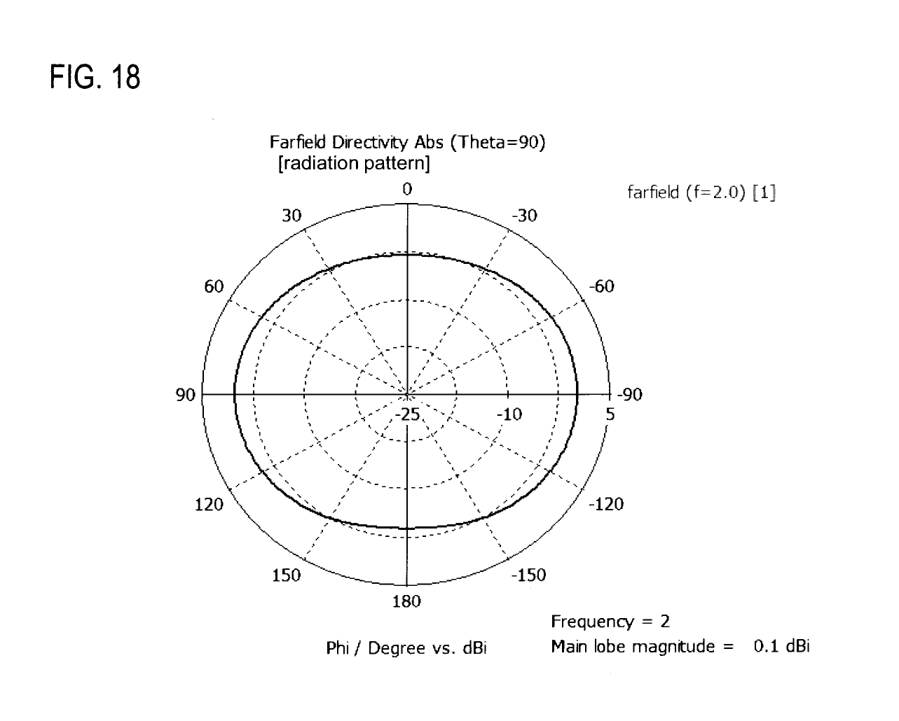

Here, as an example, the frequency characteristics of return loss S₁₁ of the vertically polarized antenna 1 shown in FIG. 16 is shown in FIG. 17. The vertically polarized antenna 1 shown in FIG. 16 includes two feeding conductors 10a and 10b and two short-circuit conductors 15a and 15b; the feeding conductor 10a and the short-circuit conductor 15a constitute one group; and the feeding conductor 10b and the short-circuit conductor 15b constitute one group. The groups are arranged at symmetrical positions with the center of the conductor plate 20 (which may be also referred to as “the center of the ground plate 30” in a broad sense) as a center. A connection portion between the short-circuit conductor 15a and the conductor plate 20 is positioned on a straight line connecting a connection portion between the feeding conductor 10a and the conductor plate 20 and the center of the conductor plate 20, between the connection portion and the edge of the conductor plate 20; and a connection portion between the short-circuit conductor 15b and the conductor plate 20 is positioned on a straight line connecting a connection portion between the feeding conductor 10b and the conductor plate 20 and the center of the conductor plate 20, between the connection portion and the edge of the conductor plate 20. FIG. 17 shows the return loss S₁₁ at the time when, in order to cause antenna resonance frequency to become 2 GHz, the following are set: L₁=6 mm=0.04λ_{2GHz}, the distance D between a feeding conductor 10 and a short-circuit conductors 15 to be grouped therewith=10.5 mm=0.07λ_{2GHz}, the diameter of the ground plate 30=135 mm=0.9λ_{2GHz}, the diameter of the conductor plate 20=48 mm=0.32λ_{2GHz}, and the distance E between the center of the conductor plate 20 and each feeding conductor 10 is changed (a symbol sp in FIG. 17 indicates D+E). It is seen from FIG. 17 that a fractional bandwidth becomes larger as the distance E becomes longer. In comparison with the diameter of the conductor plate 20 in the conventional example shown in FIG. 6, it is seen that, in this example, the diameter of the conductor plate 20 is 4 mm smaller, and downsizing of the antenna is realized. Furthermore, since the radiation pattern in a horizontal plane of the vertically polarized antenna 1 shown in FIG. 16 is almost the same as that of the conventional example shown in FIG. 8 though the level decreases a little in directions in which the two short-circuit conductors 15 are arranged (see FIG. 18), it is known that, according to this example, the fractional bandwidth can be enlarged without deteriorating the radiation pattern in a horizontal plane. In FIG. 18, a symbol Phi indicates an azimuth angle relative to XYZ orthogonal coordinate axes shown in FIG. 16.

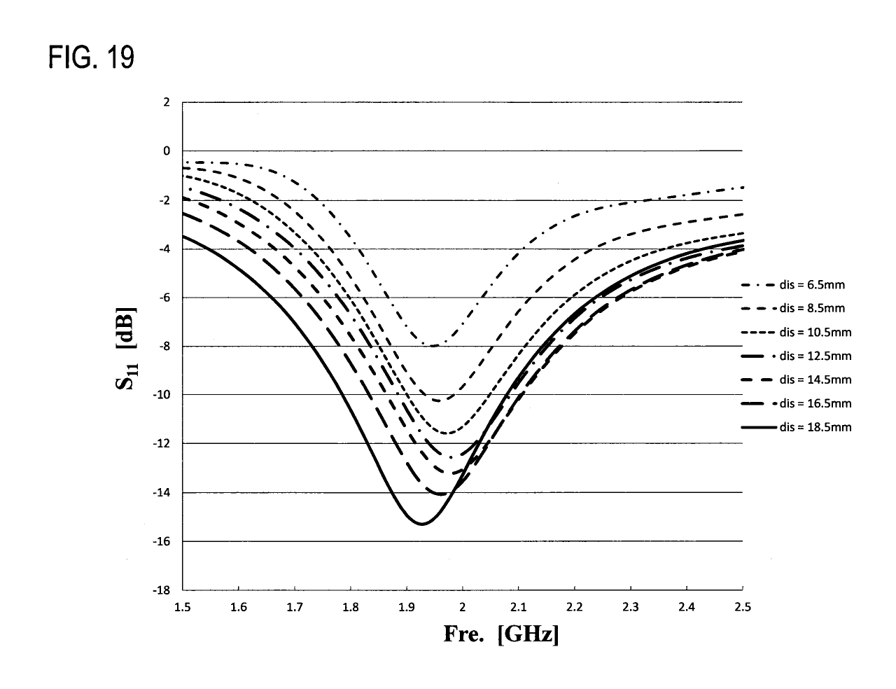

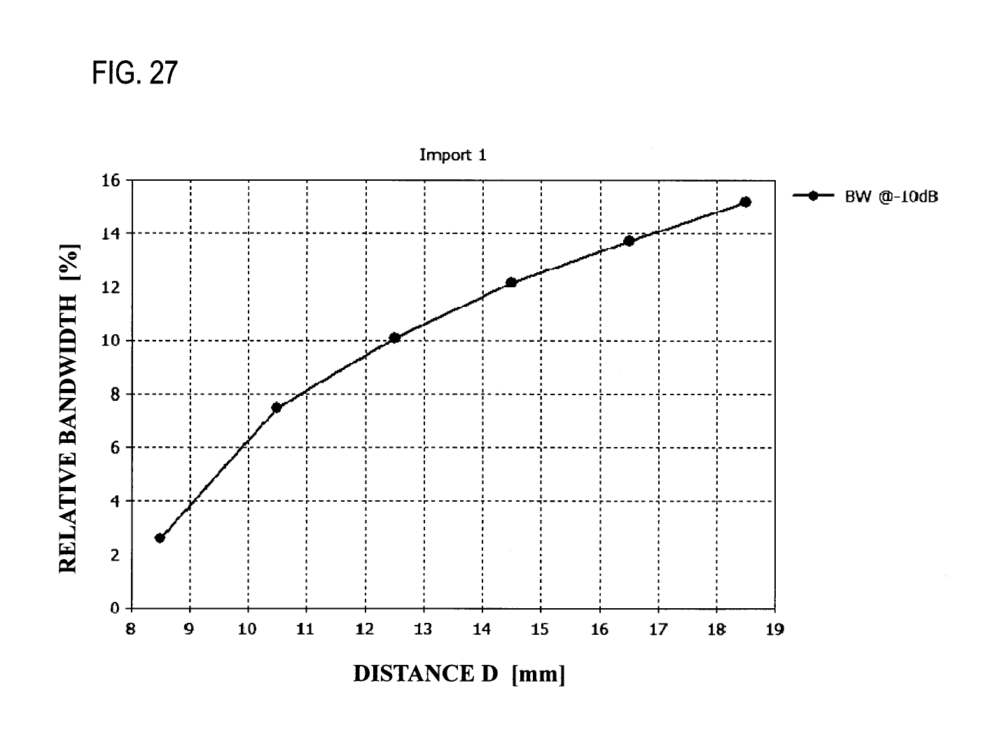

FIG. 19 shows the frequency characteristics of the return loss S₁₁ when the distance D is changed while the distance sp (=D+E)=22 mm=0.15λ_{2GHz} is fixed, in the vertically polarized antenna 1 shown in FIG. 16. FIG. 27 shows a relationship between the distance D and relative bandwidth. It is seen from FIGS. 19 and 27 that relative bandwidth becomes larger as the distance D becomes longer. It is also seen from FIG. 19 that, since the antenna resonance frequency does not change almost at all even when the distance D is changed, impedance matching is easy.

In order to realize omni-directionality in a horizontal plane (a plane parallel to the ground plate 30) of the vertically polarized antenna 1, it is desirable that at least three feeding conductors 10 are provided at positions at equal intervals relative to the center of the conductor plate 20, and, furthermore, it is desirable that at least three feeding conductors 10 are provided at positions at equal distances from the center of the conductor plate 20. In the example shown in FIG. 10, the three feeding conductors 10a, 10b and 10c are arranged at intervals of 120 degrees relative to the center of the conductor plate 20, and, furthermore, they exist at positions at equal distances from the center of the conductor plate 20. In the example shown in FIG. 11, the four feeding conductors 10a, 10b, 10c and 10d are arranged at intervals of 90 degrees relative to the center of the conductor plate 20, and, furthermore, they exist at positions at equal distances from the center of the conductor plate 20.

In the vertically polarized antenna 1, signals with the same amplitude and the same phase are fed to the feeding conductors 10.

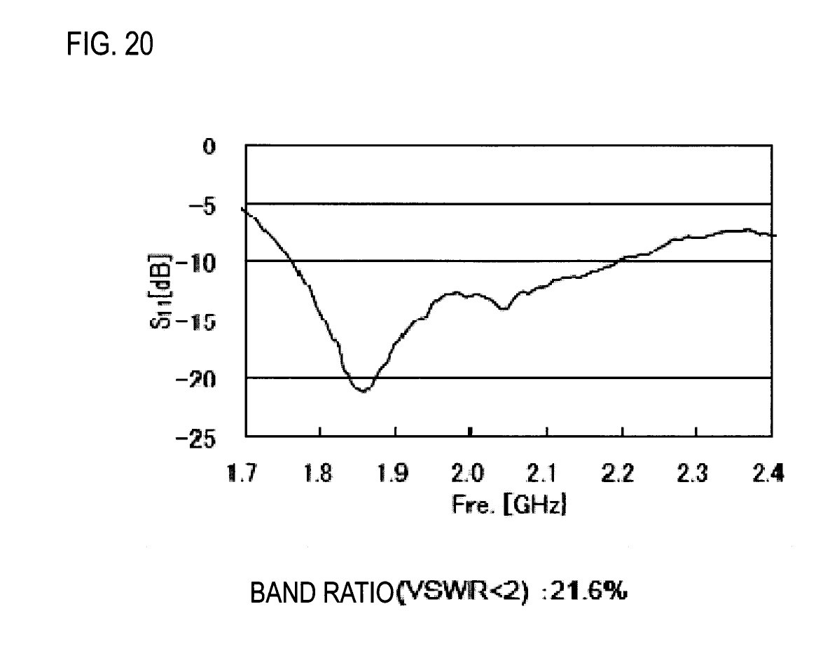

With the vertically polarized antenna 1 shown in FIG. 10, when three short-circuit conductors 15 are arranged so as to realize omni-directionality in a horizontal plane, and the following are set: design frequency=2 GHz, the distance L₁ between the ground plate 30 and the conductor plate 20=6 mm=0.04λ_{2GHz}, the distance D between a feeding conductor 10 and a short-circuit conductor 15 to be grouped therewith=6.5 mm=0.04λ_{2GHz}, the distance E between the center of the conductor plate 20 and each feeding conductor 10=17.5 mm=0.12λ_{2GHz}, the diameter of the ground plate 30=135 mm=0.9λ_{2GHz}, and the diameter of the conductor plate 20=68 mm=0.45λ_{2GHz}, the relative bandwidth under the condition that return loss S₁₁ is −10 dB or below dB, that is, VSWR<2.0; VSWR is Voltage Standing Wave Ratio) is 21.6% (see FIG. 20).

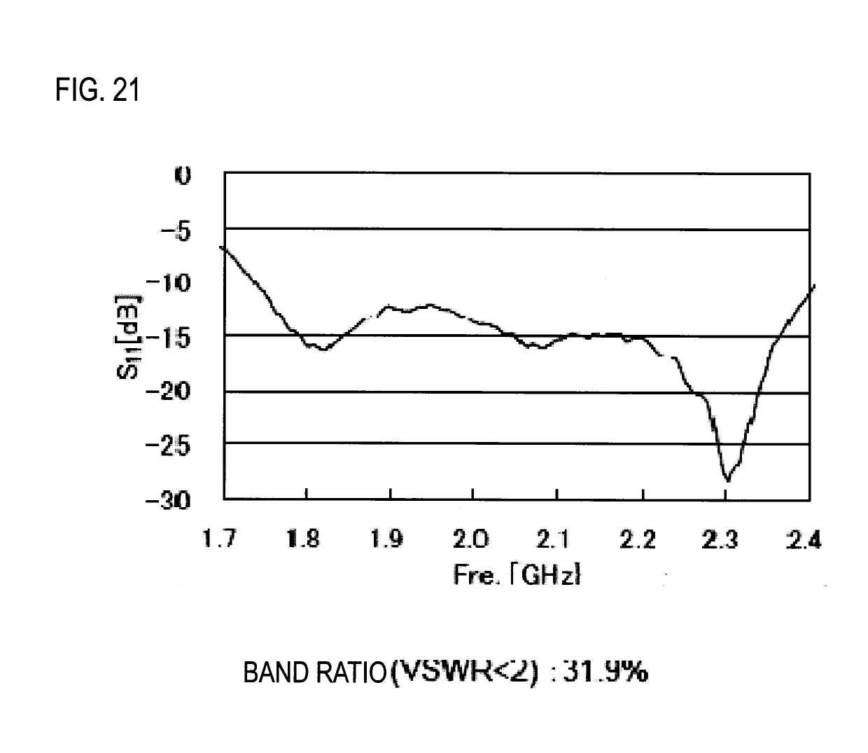

With the vertically polarized antenna 1 shown in FIG. 11, when four short-circuit conductors 15 are arranged so as to realize omni-directionality in a horizontal plane, and the following are set: design frequency=2 GHz, the distance L₁ between the ground plate 30 and the conductor plate 20=6 mm=0.04λ_{2GHz}, the distance D between a feeding conductor 10 and a short-circuit conductor 15 to be grouped therewith=6.5 mm=0.04λ_{2GHz}, the distance E between the center of the conductor plate 20 and each feeding conductor 10=17.5 mm=0.12λ_{2GHz}, the diameter of the ground plate 30=135 mm=0.9λ_{2GHz}, and the diameter of the conductor plate 20=68 mm=0.45λ_{2GHz}, the relative bandwidth under the condition that return loss S₁₁ is −10 dB or below (|S₁₁|≦−10 dB, that is, VSWR<2.0; VSWR is Voltage Standing Wave Ratio) is 31.9% (see FIG. 21).

As described above, it is understood that, according to the present invention, it is possible to realize a vertically polarized antenna having a relative bandwidth much larger than a conventional one while having the same thin thickness as the conventional one against vertically polarized waves.

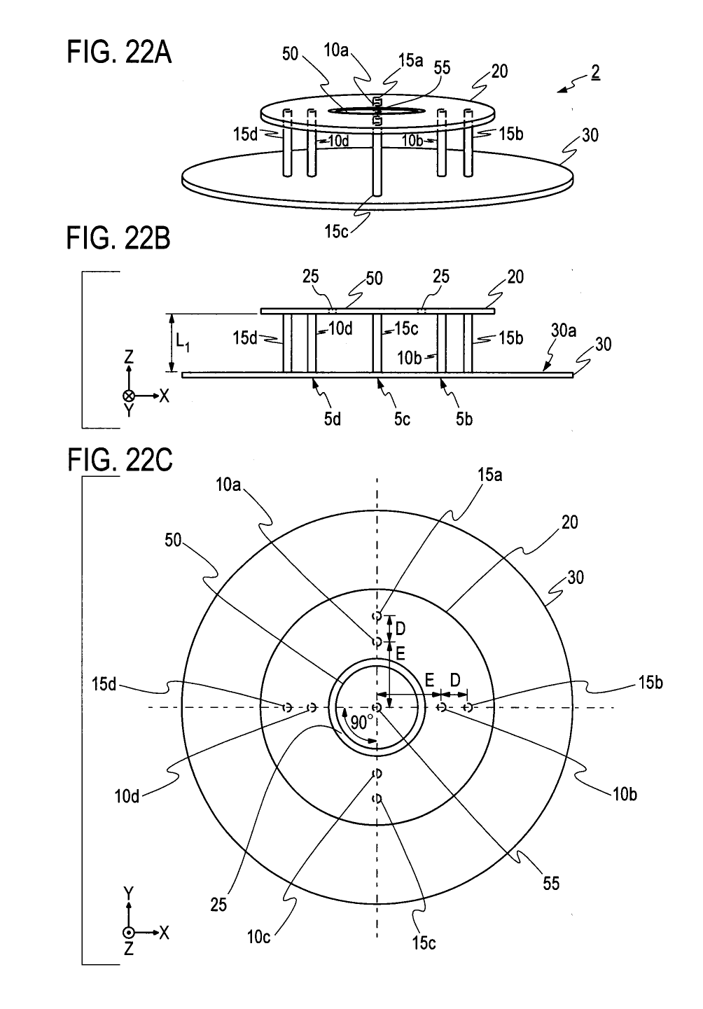

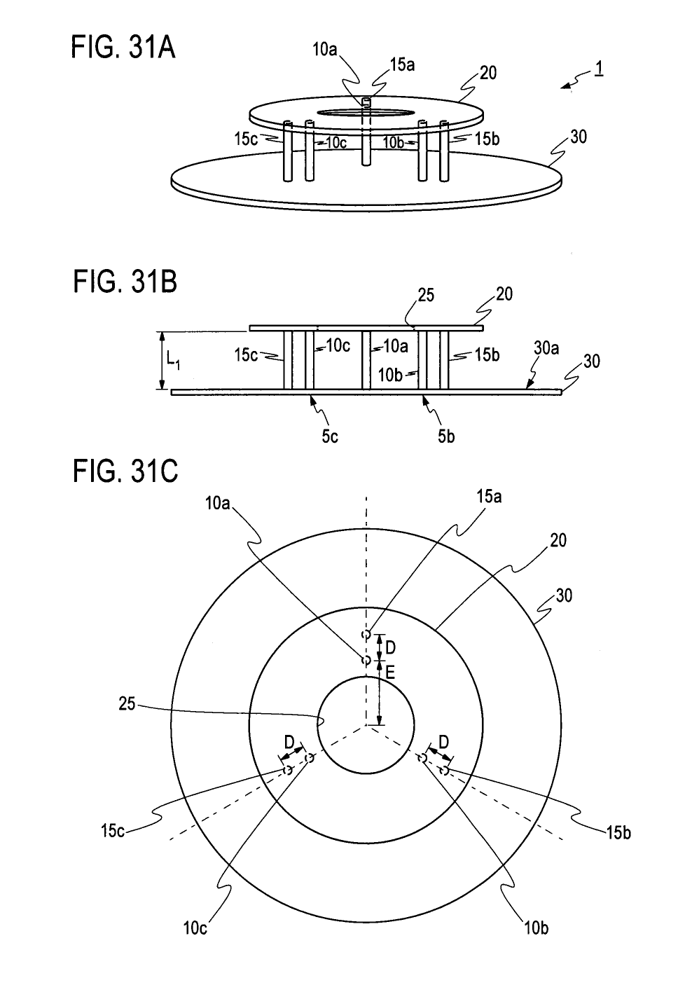

As shown in FIG. 12, since the electrical potential near the center of the conductor plate 20 is almost zero, for example, a ring-shaped flat plate (a holed circular plate) can be adopted as the shape of the conductor plate 20, as described above (see, for example, FIG. 31 as a modification of the antenna shown in FIG. 10). A vertically polarized antenna 2 utilizing the hole, which is a modification of the vertically polarized antenna 1, is shown in FIG. 22.

The shape of the conductor plate 20 in the vertically polarized antenna 2 is a ring having a circular hole 25. Hereinafter, the conductor plate 20 will be called a ring-shaped conductor plate 20. The hole 25 is formed such that the center of the ring-shaped conductor plate 20 (according to the above definition, the center of the outer circle of the ring-shaped conductor plate 20) corresponds to the center of the hole 25. The vertically polarized antenna 2 further has a conductor plate 50 and a stick-shaped short-circuit conductor 55.

The conductor plate 50 is arranged in the hole 25 such that the conductor plate 50 is not contact with the ring-shaped conductor plate 20 and is parallel to the ground plate 30. The shape of the conductor plate 50 is not limited. A shape similar to the hole 50 can be adopted. In this example, the conductor plate 50 is a circular plate with a diameter smaller than the inner diameter of the ring-shaped conductor plate 20. In this example, the conductor plate 50 is arranged such that the center of the conductor plate 50 corresponds to the center of the ring-shaped conductor plate 20.

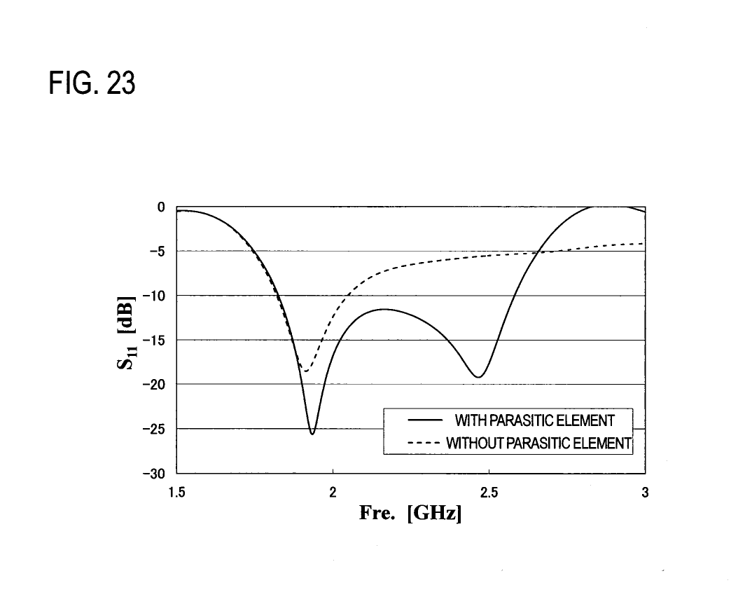

In FIG. 22, the conductor plate 50 is arranged on a plane where the ring-shaped conductor plate 20 is arranged (in other words, the distance between the ground plate 30 and the ring-shaped conductor plate 20 is equal to the distance between the ground plate 30 and the conductor plate 50). However, the configuration is not limited to such a configuration. That is, the plane where the ring-shaped conductor plate 20 is arranged and the plane where the conductor plate 50 is arranged may be different (in other words, the distance between the ground plate 30 and the ring-shaped conductor plate 20 and the distance between the ground plate 30 and the conductor plate 50 are different). In this case, by appropriately setting the distance between the ground plate 30 and the conductor plate 50, a resonance frequency different from a design frequency in the case of not providing the conductor plate 50 (see FIG. 23 to be described later for the details) can be adjusted. When this is explained from a different viewpoint, the conductor plate 50 is arranged parallel to the ground plate 30 such that the whole of the conductor plate 50 is included in the hole 25 when seen from the direction of the normal line of the ground plate 30. In other words, when the conductor plate 50 is orthogonally projected along the direction of the normal line of the ground plate 30, the projection of the conductor plate 50 is included in the hole 25.

The conductor plate 50 and the ground plate 30 are connected via the short-circuit conductor 55. In this example, the center of the conductor plate 50 and the center of the ground plate 30 in a narrow sense are connected via the short-circuit conductor 55.

FIG. 23 shows the frequency characteristics of the return loss S₁₁ of the vertically polarized antenna 2 when the following are set: the design frequency=2 GHz, the distance L₁ between the ground plate 30 and the ring-shaped conductor plate 20, and between the ground plate 30 and the conductor plate 50=6 mm=0.04λ_{2GHz}, the distance D between a feeding conductor 10 and a short-circuit conductor 15 to be grouped therewith=6.5 mm=0.04λ_{2GHz}, the distance E between the center of the ring-shaped conductor plate 20 and each feeding conductor 10=17.5 mm=0.12λ_{2GHz}, the diameter of the ground plate 30=137 mm=0.9λ_{2GHz}, the diameter of the hole 25=30 mm=0.2λ_{2GHz}, and the diameter of the conductor plate 50=16 mm=0.11λ_{2GHz}. FIG. 23 also shows the frequency characteristics of the return loss S₁₁ of an antenna having a configuration obtained by removing the conductor plate 50 and the short-circuit conductor 55 from the configuration of the vertically polarized antenna 2 shown in FIG. 22.

It is seen from FIG. 23 that, by adding the conductor plate 50 and the short-circuit conductor 55 which are parasitic elements, a resonance frequency of 2.46 GHz different from 1.93 GHz close to the design frequency (2 GHz) appears, and, as a result, the bandwidth of the vertically polarized antenna 2 is enlarged.

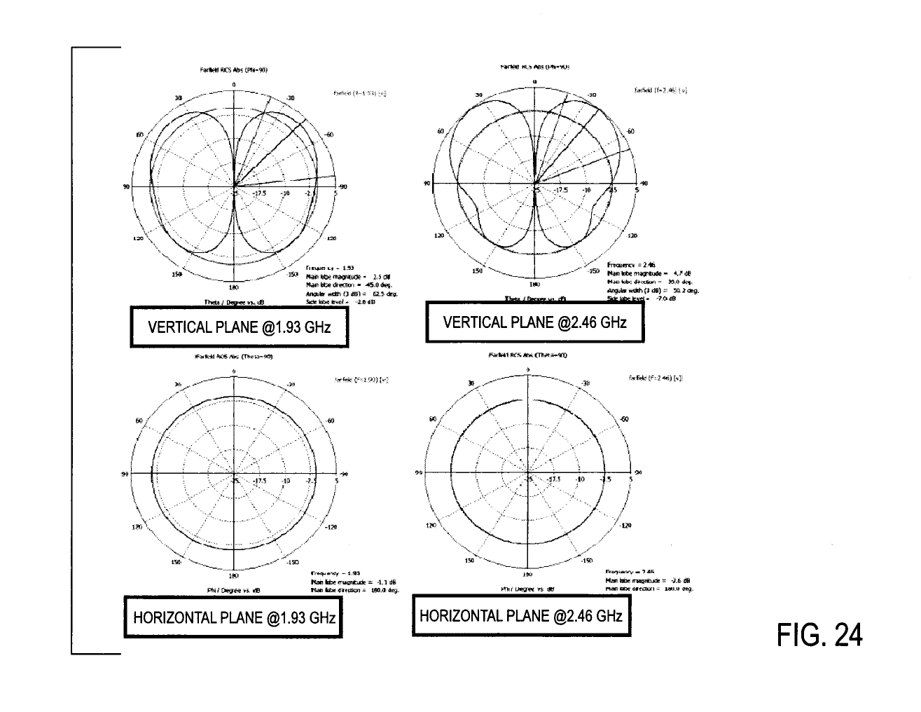

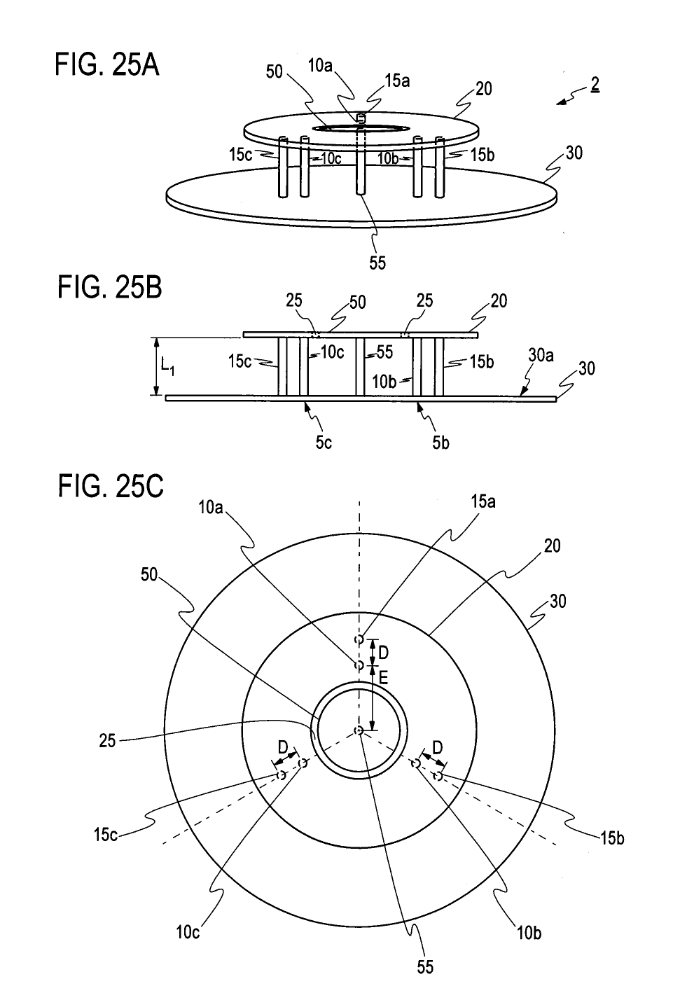

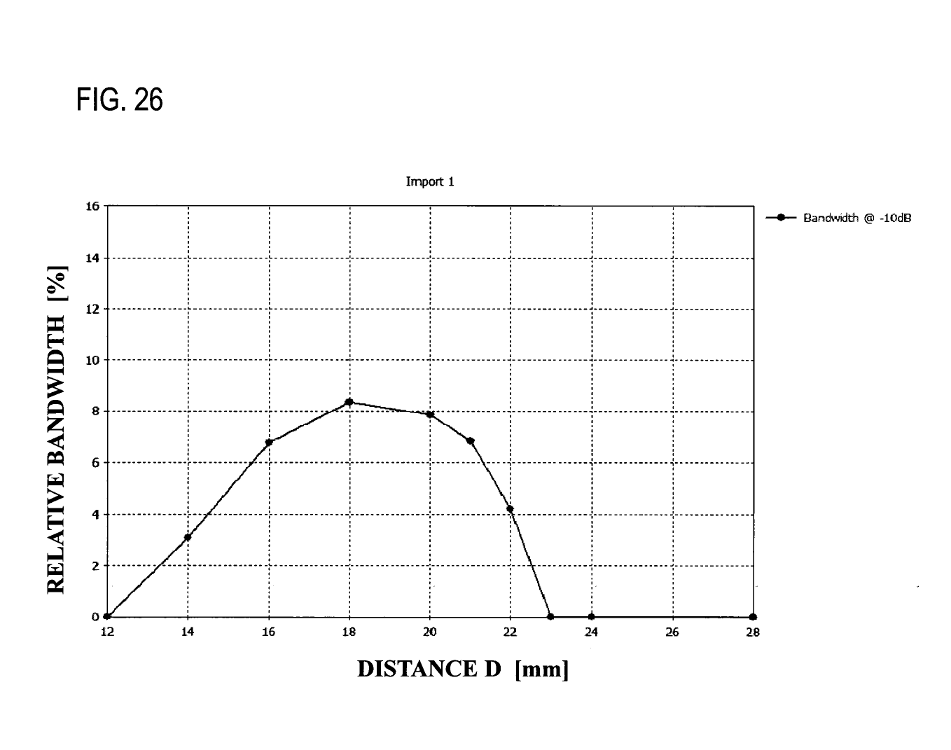

FIG. 24 shows the radiation pattern in a vertical plane and radiation pattern in a horizontal plane of the vertically polarized antenna 2. In FIG. 24, a symbol Phi indicates an azimuth angle relative to XYZ orthogonal coordinate axes, and a symbol Theta indicates a polar angle. From these, it is seen that the vertically polarized antenna 2 also can realize characteristics similar to those of a dipole antenna.

Whereas the vertically polarized antenna 2, which is a modification of the vertically polarized antenna 1 shown in FIG. 11, is shown in FIG. 22, the vertically polarized antenna 2 in the case where a ring-shaped flat plate (a holed circular plate) is adopted as the shape of the conductor plate 20 is shown in FIG. 25 as a modification of the vertically polarized antenna 1 shown in FIG. 10. In comparison with the vertically polarized antenna 2 shown in FIG. 22, the vertically polarized antenna 2 shown in FIG. 25 is different in the number and arrangement of the feeding conductors 10 and the number and arrangement of the short-circuit conductors 15. However, since this difference is caused by difference between the vertically polarized antenna 1 shown in FIG. 10 and the vertically polarized antenna 1 shown in FIG. 11, description of the structure of the vertically polarized antenna 2 shown in FIG. 25 will be omitted.

1-8. (canceled)

9. A vertically polarized antenna comprising:
a ground plate;
a conductor plate;
two or more feeding conductors; and
short-circuit conductors grouped with the feeding conductors, respectively; wherein
the conductor plate is arranged parallel to the ground plate such that the whole of the conductor plate is overlapped with the ground plate when seen from a direction of a normal line of the ground plate;
each of the feeding conductors connects the ground plate and the conductor plate at a position different from a center of the conductor plate; and
each of the short-circuit conductors connects the ground plate and the conductor plate near the feeding conductor grouped with the short-circuit conductor.

10. The vertically polarized antenna according to claim 9, wherein
each of the short-circuit conductors is positioned near the feeding conductor grouped with the short-circuit conductor on a side away from the center of the conductor plate.

11. The vertically polarized antenna according to claim 9, wherein
power is fed to each of the feeding conductors with the same amplitude and the same phase,
directivity in a horizontal plane is omni-directionality.

12. The vertically polarized antenna according to claim 10, wherein
power is fed to each of the feeding conductors with the same amplitude and the same phase,
directivity in a horizontal plane is omni-directionality.

13. The vertically polarized antenna according to claim 10, wherein
each of the feeding conductors and each of the short-circuit conductors is arranged parallel to the normal line direction.

14. The vertically polarized antenna according to claim 11, wherein
each of the feeding conductors and each of the short-circuit conductors is arranged parallel to the normal line direction.

15. The vertically polarized antenna according to claim 12, wherein
each of the feeding conductors and each of the short-circuit conductors is arranged parallel to the normal line direction.

16. The vertically polarized antenna according to claim 13, wherein
the feeding conductors are provided at equal distances from the center of the conductor plate and at equal intervals relative to the center of the conductor plate.

17. The vertically polarized antenna according to claim 14, wherein
the feeding conductors are provided at equal distances from the center of the conductor plate and at equal intervals relative to the center of the conductor plate.

18. The vertically polarized antenna according to claim 15, wherein
the feeding conductors are provided at equal distances from the center of the conductor plate and at equal intervals relative to the center of the conductor plate.

19. The vertically polarized antenna according to claim 13, wherein
the number of the short-circuit conductors is a positive integral multiple of the number of the feeding conductors.

20. The vertically polarized antenna according to claim 14, wherein
the number of the short-circuit conductors is a positive integral multiple of the number of the feeding conductors.

21. The vertically polarized antenna according to claim 15, wherein
the number of the short-circuit conductors is a positive integral multiple of the number of the feeding conductors.

22. The vertically polarized antenna according to claim 16, wherein
the number of the short-circuit conductors is a positive integral multiple of the number of the feeding conductors.

23. The vertically polarized antenna according to claim 17, wherein
the number of the short-circuit conductors is a positive integral multiple of the number of the feeding conductors.

24. The vertically polarized antenna according to claim 18, wherein
the number of the short-circuit conductors is a positive integral multiple of the number of the feeding conductors.

25. The vertically polarized antenna according to claim 9, wherein
the conductor plate is a flat plate having a hole in its central part;
the conductor plate comprises:
a second conductor plate arranged such that the second conductor is not in contact with the conductor plate; and
a second short-circuit conductor connecting the second conductor plate and the ground plate; and
the conductor plate is arranged parallel to the ground plate such that the whole of the second conductor plate appears to be included in the hole when seen from the direction of the normal line of the ground plate.

26. The vertically polarized antenna according to claim 10, wherein
the conductor plate is a flat plate having a hole in its central part;
the conductor plate comprises:
a second conductor plate arranged such that the second conductor is not in contact with the conductor plate; and
a second short-circuit conductor connecting the second conductor plate and the ground plate; and
the conductor plate is arranged parallel to the ground plate such that the whole of the second conductor plate appears to be included in the hole when seen from the direction of the normal line of the ground plate.

27. The vertically polarized antenna according to claim 11, wherein
the conductor plate is a flat plate having a hole in its central part;
the conductor plate comprises:
a second conductor plate arranged such that the second conductor is not in contact with the conductor plate; and
a second short-circuit conductor connecting the second conductor plate and the ground plate; and
the conductor plate is arranged parallel to the ground plate such that the whole of the second conductor plate appears to be included in the hole when seen from the direction of the normal line of the ground plate.

28. The vertically polarized antenna according to claim 12, wherein
the conductor plate is a flat plate having a hole in its central part;
the conductor plate comprises:
a second conductor plate arranged such that the second conductor is not in contact with the conductor plate; and
a second short-circuit conductor connecting the second conductor plate and the ground plate; and
the conductor plate is arranged parallel to the ground plate such that the whole of the second conductor plate appears to be included in the hole when seen from the direction of the normal line of the ground plate.

29. The vertically polarized antenna according to claim 13, wherein
the conductor plate is a flat plate having a hole in its central part;
the conductor plate comprises:
a second conductor plate arranged such that the second conductor is not in contact with the conductor plate; and
a second short-circuit conductor connecting the second conductor plate and the ground plate; and
the conductor plate is arranged parallel to the ground plate such that the whole of the second conductor plate appears to be included in the hole when seen from the direction of the normal line of the ground plate.

30. The vertically polarized antenna according to claim 14, wherein
the conductor plate is a flat plate having a hole in its central part;
the conductor plate comprises:
a second conductor plate arranged such that the second conductor is not in contact with the conductor plate; and
a second short-circuit conductor connecting the second conductor plate and the ground plate; and
the conductor plate is arranged parallel to the ground plate such that the whole of the second conductor plate appears to be included in the hole when seen from the direction of the normal line of the ground plate.

31. The vertically polarized antenna according to claim 15, wherein
the conductor plate is a flat plate having a hole in its central part;
the conductor plate comprises:
a second conductor plate arranged such that the second conductor is not in contact with the conductor plate; and
a second short-circuit conductor connecting the second conductor plate and the ground plate; and
the conductor plate is arranged parallel to the ground plate such that the whole of the second conductor plate appears to be included in the hole when seen from the direction of the normal line of the ground plate.

32. The vertically polarized antenna according to claim 16, wherein
the conductor plate is a flat plate having a hole in its central part;
the conductor plate comprises:
a second conductor plate arranged such that the second conductor is not in contact with the conductor plate; and
a second short-circuit conductor connecting the second conductor plate and the ground plate; and
the conductor plate is arranged parallel to the ground plate such that the whole of the second conductor plate appears to be included in the hole when seen from the direction of the normal line of the ground plate.

33. The vertically polarized antenna according to claim 17, wherein
the conductor plate is a flat plate having a hole in its central part;
the conductor plate comprises:
a second conductor plate arranged such that the second conductor is not in contact with the conductor plate; and
a second short-circuit conductor connecting the second conductor plate and the ground plate; and
the conductor plate is arranged parallel to the ground plate such that the whole of the second conductor plate appears to be included in the hole when seen from the direction of the normal line of the ground plate.

34. The vertically polarized antenna according to claim 18, wherein
the conductor plate is a flat plate having a hole in its central part;
the conductor plate comprises:
a second conductor plate arranged such that the second conductor is not in contact with the conductor plate; and
a second short-circuit conductor connecting the second conductor plate and the ground plate; and
the conductor plate is arranged parallel to the ground plate such that the whole of the second conductor plate appears to be included in the hole when seen from the direction of the normal line of the ground plate.

35. The vertically polarized antenna according to claim 19, wherein
the conductor plate is a flat plate having a hole in its central part;
the conductor plate comprises:
a second conductor plate arranged such that the second conductor is not in contact with the conductor plate; and
a second short-circuit conductor connecting the second conductor plate and the ground plate; and
the conductor plate is arranged parallel to the ground plate such that the whole of the second conductor plate appears to be included in the hole when seen from the direction of the normal line of the ground plate.

36. The vertically polarized antenna according to claim 20, wherein
the conductor plate is a flat plate having a hole in its central part;
the conductor plate comprises:
a second conductor plate arranged such that the second conductor is not in contact with the conductor plate; and
a second short-circuit conductor connecting the second conductor plate and the ground plate; and
the conductor plate is arranged parallel to the ground plate such that the whole of the second conductor plate appears to be included in the hole when seen from the direction of the normal line of the ground plate.

37. The vertically polarized antenna according to claim 21, wherein
the conductor plate is a flat plate having a hole in its central part;
the conductor plate comprises:
a second conductor plate arranged such that the second conductor is not in contact with the conductor plate; and
a second short-circuit conductor connecting the second conductor plate and the ground plate; and
the conductor plate is arranged parallel to the ground plate such that the whole of the second conductor plate appears to be included in the hole when seen from the direction of the normal line of the ground plate.

38. The vertically polarized antenna according to claim 22, wherein
the conductor plate is a flat plate having a hole in its central part;
the conductor plate comprises:
a second conductor plate arranged such that the second conductor is not in contact with the conductor plate; and
a second short-circuit conductor connecting the second conductor plate and the ground plate; and
the conductor plate is arranged parallel to the ground plate such that the whole of the second conductor plate appears to be included in the hole when seen from the direction of the normal line of the ground plate.

39. The vertically polarized antenna according to claim 23, wherein
the conductor plate is a flat plate having a hole in its central part;
the conductor plate comprises:
a second conductor plate arranged such that the second conductor is not in contact with the conductor plate; and
a second short-circuit conductor connecting the second conductor plate and the ground plate; and
the conductor plate is arranged parallel to the ground plate such that the whole of the second conductor plate appears to be included in the hole when seen from the direction of the normal line of the ground plate.

40. The vertically polarized antenna according to claim 24, wherein
the conductor plate is a flat plate having a hole in its central part;
the conductor plate comprises:
a second conductor plate arranged such that the second conductor is not in contact with the conductor plate; and
a second short-circuit conductor connecting the second conductor plate and the ground plate; and
the conductor plate is arranged parallel to the ground plate such that the whole of the second conductor plate appears to be included in the hole when seen from the direction of the normal line of the ground plate.
